(19) United States
(12) Patent Application Publication
(10) Pub. No.: US 2024/0365742 A1
(43) Pub. Date: Nov. 7, 2024

(54) LIVESTOCK-HOUSING VENTILATION SYSTEM

(71) Applicant: ECOCOOLING LIMITED, Bury St. Edmunds (GB)

(72) Inventor: Alan Beresford, Bury St. Edmunds (GB)

(21) Appl. No.: 18/254,298

(22) PCT Filed: Nov. 26, 2021
(86) PCT No.: PCT/GB2021/053081

§ 371 Date: May 24, 2023

(30) Foreign Application Priority Data
Nov. 27, 2020 (GB) 2018753.0
Mar. 17, 2021 (GB) 2103707.2
Aug. 27, 2021 (GB) 2112320.3

(51) Int. Cl. A01K 1/00

(52) U.S. Cl. CPC A01K 1/0076

(57) ABSTRACT

A livestock-housing ventilation system for delivering air to the interior of a livestock housing comprises: a first air inlet arranged to provide a stream of ambient air to the interior of the housing: an outlet for air to be exhausted out of the housing: a reversible fan configurable to operate in a first airflow direction, in which the fan directs a flow of air from the housing towards the outlet, or a second airflow direction, in which the fan directs air away from the outlet and into the housing: a recirculation damper arranged between the reversible fan and the outlet; and a controller for controlling the fan. A controller for a ventilation system and a livestock-housing are also provided.

The invention relates to a livestock-housing ventilation system and a livestock housing comprising a ventilation system.

### BACKGROUND

Huge numbers of livestock are raised worldwide every year, with many varieties of livestock spending at least part of the year living in livestock-housing to shelter them from adverse weather. Some varieties of livestock, for example fowl such as chickens, ducks, or turkeys, may spend some or all of their lives inside livestock housing such as large purpose-built sheds.

Typically, livestock housing such as chicken sheds are provided with many windows and/or vents to provide a through-flow of fresh air, and heaters that can be turned on to ensure the temperature in the sheds does not get too low. Some livestock housing, for example in warmer countries, may also be provided with evaporative coolers that can cool incoming air on particularly hot days. Problems with these systems exist, however, in that the heating systems are typically inefficient and ineffective, as heaters are typically hung from the roof of the building, adjacent to the exhaust vents, and in that both hot and cold air tend to be distributed unevenly throughout the housing. Additionally, in temperate countries like the UK for example, the increasing frequency of heat waves and extremely hot weather has caused problems for livestock housing that is poorly equipped to provide adequate cooling throughout the housing.

The provision of optimal ventilation for livestock housing is significantly complicated by the fact that the best environmental conditions for the livestock will vary throughout the life of the animals. Taking broilers (chickens raised for meat) as an example, the broilers may be housed in the same broiler house from the time of hatching as an egg on the floor of the broiler house, until they are fully grown at around 40 days after hatching. During the final stages of egg incubation and hatching, the temperature in the broiler house should be kept at a high temperature of around 34° C., and then as the chicks develop feathers and grow larger, the optimal temperature for the broilers will gradually reduce to around 20° C. at full growth after 40 days.

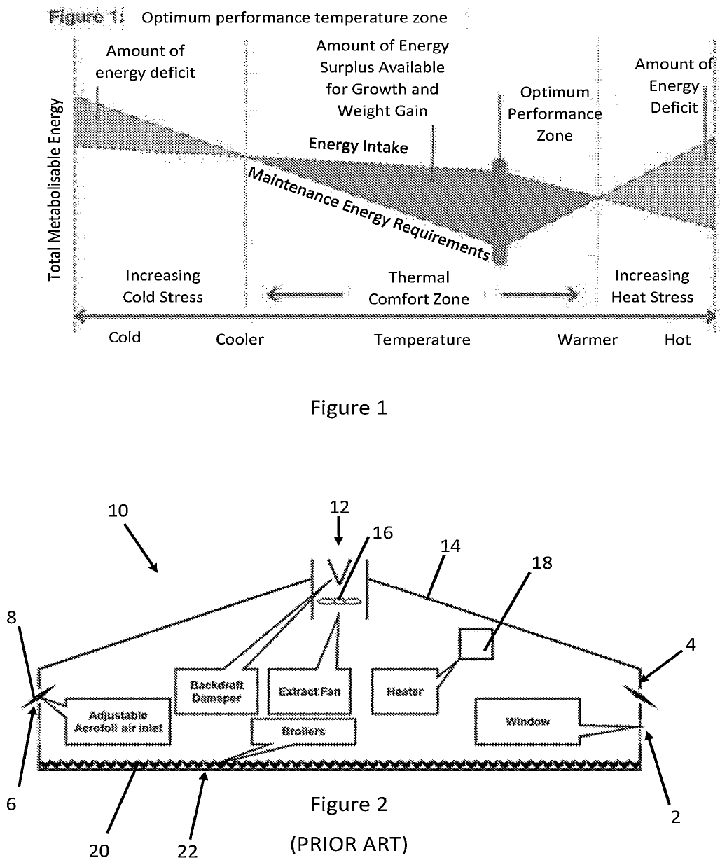

As shown in FIG. 1, at any given stage of livestock development, there is an optimum performance temperature zone at which the livestock (in this case broilers) are most comfortable and have the most surplus energy available for growth. At this point the livestock are neither too hot nor too cold, and the food conversion yield of the livestock to weight gain is at a maximum. At lower temperatures, the livestock require more energy to stay warm, so that they have less surplus energy available for growth and weight gain, while at higher temperatures the livestock require more energy to stay cool, which also reduces the surplus energy available for growth. At very cold and very hot temperatures, livestock can also suffer from cold stress or heat stress respectively, so it is highly important to control air conditions in the housing to keep the livestock within their thermal comfort zone regardless of where they are in the housing.

Livestock housing such as broiler houses are typically large structures with two end walls, two side walls, and a gable roof. The floor of the housing is typically covered with bedding material, and livestock lives on the floor of the house.

A conventional broiler house is illustrated in FIG. 2. Windows are provided in the side walls to provide ventilation, and air inlets above the windows are provided with adjustable aerofoil louvres, to direct the flow of outside air, termed “ambient” air, in through the air inlets. A series of air outlets are provided at intervals along the peak of the gable roof, each outlet having its own extract fan which continually blows air vertically upwards out of the housing through the outlet. Lighting and one or more heaters are suspended from the gable roof.

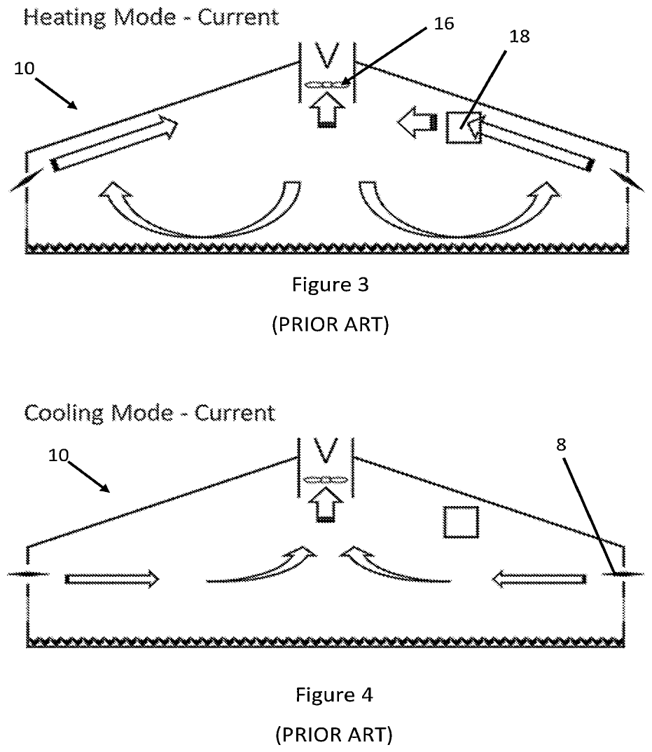

As shown in FIG. 3, when the weather is cold, the heaters are turned on and the aerofoil louvres are pointed upwards to direct cold air away from the broilers and also to restrict flow to create a negative pressure in the building by running the extract fan. The theory behind this is that this increases the velocity of the air coming into the housing, which creates the mixing of the hot air from the heater with the cold air entering through the air inlets.

There are multiple problems with heating in this prior art design. Firstly, heating costs are high because the heating mode of the housing relies upon bringing cold ambient air into the housing to create a jet mixing effect with the heated air. In addition, the extract fans are typically unidirectional, fixed speed fans, so in order to achieve a desired air flow the fans must be pulsed, which is extremely energy-inefficient. The internal temperature conditions are not homogenous throughout the housing, due to poor mixing of hot and cold air, due to the unreliable jet mixing and fan pulsing. Some hot air from the heaters is immediately lost through the air outlets, as the heaters are mounted on the roof near the outlets. This system also provides a lack of control over airflows and temperatures. This means that broilers in some areas of the housing may be too cold, while those in other areas may be too hot.

Many prior art broiler houses use direct gas fired heaters. An added problem arising from inefficient heating is the increase in relative humidity due to water being one of the products of combustion. This can lead to high relative humidity (RH) in the broiler house, which can cause ammonia problems and be detrimental to the welfare of the broilers. The products of combustion can also be detrimental to the health of animals. Inefficient heating leads to excessive fuel use which exacerbates this issue.

As shown in FIG. 4, when the weather is warm, the aerofoil louvres of the prior art broiler house are positioned horizontally to maximise the flow of ambient air in through the air inlets. Ambient air is drawn across the room removing the heat generated from the broilers, and cooling them down.

There are serious problems with cooling in this prior art design. The main problem in hot weather is that the temperature conditions within the housing are not homogenous—the broilers closest to the air inlets are coldest, while those further from the air inlets receive less cooling air. In very hot weather it may be impossible to keep the broilers in the centre of the floor cool, which is detrimental to the welfare of those birds. The lack of homogeneity leads to many birds not being in thermo-neutral conditions. This leads to reduced efficiency of food conversion. It also leads to variation in bird weight at the end of the crop which has commercial implications in the sale to meat processors and retailers.

In very hot weather many prior art broiler houses use a ‘tunnel’ ventilation system in which gable end fans draw a large volume of air through the building. Again, this leads to uneven temperatures so that broilers in different locations in the housing will experience different temperature conditions.

In order to improve the welfare of livestock housed in such livestock housing, it is desirable to provide a ventilation system that is more adaptable to both hot and cold weather, able to create uniform temperature and humidity conditions throughout the housing, and controllable to provide the most comfortable temperature and humidity conditions for the livestock housed in the housing.

### SUMMARY OF THE INVENTION

The invention provides a livestock-housing ventilation system and a livestock housing comprising a ventilation system, as defined in the appended independent claims to which reference should now be made. Preferred or advantageous features of the invention are set out in the dependent subclaims.

The livestock housing of the present invention may be any building or structure used to house livestock, or domesticated animals. For example, the livestock housing may be a barn, shed or warehouse used to house for cattle, sheep, pigs or other farmed animals during at least part of the animals' life cycles or during at least part of the year. The livestock housing may be a housing for fowl such as turkeys, ducks or chickens. For example, the livestock housing may be a shed used to house chickens as they are raised from hatching. Although it will be understood that the present invention is equally applicable to livestock housing for a wide range of livestock, in the following description the invention will be described by reference to chickens, and in particular broilers, which are chickens raised for meat.

According to a first aspect of the invention there is provided a livestock-housing ventilation system for providing a stream of controlled-temperature air to the interior of livestock housing. The livestock-housing ventilation system comprises:
an air inlet arranged to provide a stream of ambient air to the interior of the housing;
an outlet for air to be exhausted out of the housing;
a reversible fan configurable to operate in a first airflow direction, in which the fan directs a flow of air from the housing towards the outlet, or a second airflow direction, in which the fan directs air away from the outlet and into the housing;
a recirculation damper arranged between the reversible fan and the outlet; and
a controller for controlling the fan.

The livestock-housing ventilation system may be a ventilation system for controlling the temperature and relative humidity of air inside the livestock housing. The livestock-housing ventilation system may be suitable for providing a stream of controlled-temperature and controlled-humidity air to the interior of livestock housing.

The livestock-housing ventilation system is preferably an automatically-controllable ventilation system, which is automatically controlled by the controller.

Unlike the prior art systems, which contain unidirectional fans for directing air out of the air outlet or exhaust, the system of the present invention comprises a reversible fan. The reversible fan can operate in either a first airflow direction, in which the fan directs a flow of air from the housing towards the outlet, or the fan can operate in a second airflow direction in which the fan directs air in the opposite direction, so that it flows away from the outlet and into the housing. This reversible fan is controllable by the controller, and allows the system to direct airflows in different directions within the interior of the livestock housing, which creates more flexibility in how airflows are mixed.

The outlet is preferably positioned in a roof or ceiling of the housing, and the reversible fan is preferably positioned in the housing and arranged to direct air upwards out of the outlet in the first airflow direction, or downwards in the second airflow direction. In the second airflow direction, the fan can therefore direct air towards the floor of the livestock housing, where the livestock, for example the broilers, are located. Directing an airflow downwards with the reversible fan may advantageously cause that airflow to mix with the air in the housing and the airflow flowing into the housing through the air inlet, to create more uniform air conditions throughout the housing.

The presence of a recirculation damper between the reversible fan and the outlet also significantly increases the capabilities of the ventilation system compared to the simple “outlet and extract fan” arrangement of the prior art. By operating the fan in the second airflow direction and opening this recirculation damper, it is advantageously possible for the fan to draw an airflow of recirculated air through the recirculation damper and to direct it into the housing, for example downwards towards the floor of the housing. When the weather is cold and heating is required, for example, this means that heated air can be recirculated through the housing to create more uniform temperature and humidity conditions and ensure the comfort of livestock throughout the housing. This may also significantly decrease the energy consumption of the heating system, as heated air may be recirculated rather than constantly exhausted and replaced by cold incoming ambient air.

The present invention therefore has the particular advantages of: creating and maintaining homogenous air conditions in the livestock housing to both improve the welfare of livestock and to maximise food conversion yield; and reducing the energy use of extract fans and heating systems.

The livestock housing may comprise two end walls, two side walls, a roof and a floor. The floor of the housing is typically covered with bedding material, and livestock lives on the floor of the livestock housing.

The air inlet may be provided in a wall of the housing, for example in a side wall. The outlet may preferably be provided in the roof of the housing, so that in hot weather, heated air rises from the livestock towards the outlet and is exhausted. The outlet is preferably configured to exhaust heated air from an upper region of the housing adjacent to the roof of the housing.

Preferably the housing may comprise a plurality of air inlets, a plurality of outlets, and a plurality of reversible fans and recirculation dampers corresponding to the plurality of outlets. The controller may preferably be programmed to control all of the plurality of fans and/or recirculation dampers.

The ventilation system may additionally comprise a closable outlet damper arranged across the outlet.

The outlet damper and the recirculation damper are preferably configurable between an exhaust position, in which the outlet damper is open and the recirculation damper does not impede airflow out of the outlet, and a recirculation position, in which the outlet damper closes, or partially closes, the outlet and the recirculation damper opens so to direct a stream of air back into the interior of the housing.

In the exhaust position, the recirculation damper is preferably closed, and the outlet damper is open. The controller is preferably programmed to operate the fan in the first airflow direction when the outlet and recirculation dampers are in the exhaust position, so that the fan directs air out of the housing through the outlet.

In the recirculation position, the recirculation damper opens, and the outlet damper either closes completely or closes partially. The controller is preferably programmed to operate the fan in the second airflow direction when the outlet and recirculation dampers are in the exhaust position, so that the fan draws air through the open recirculation damper and directs air into the housing and away from the outlet. Preferably the outlet is positioned in a roof or ceiling of the housing, and in the second airflow direction the fan directs air downwards into the housing.

The recirculation damper and/or the outlet damper may be controllable by the controller, so that the controller can control the position of the dampers between the recirculation position and the exhaust position. Alternatively, the recirculation damper and/or the outlet damper may be configured to move between the exhaust and recirculation positions in response to a pressure change resulting from a change of direction of the reversible fan. Preferably the the recirculation damper and/or the outlet damper are passive non-return dampers. For example, these dampers may be passively actuated by gravity, or by springs, in response to pressure changes caused by the direction and/or speed of the fan. Using passively actuated dampers may advantageously create a greatly simplified ventilation system and reduce installation and maintenance requirements and costs.

In a preferred embodiment, the system comprises an exhaust tunnel, the exhaust tunnel having an inlet end arranged to receive air from the interior of the housing, and an outlet end arranged at the outlet from the housing. The reversible fan is preferably positioned in the exhaust tunnel and configured to direct air in the first airflow direction towards the outlet end of the tunnel, or to direct air in the second airflow direction towards the inlet end of the tunnel. Where the outlet is provided in a roof of the housing, the exhaust tunnel is preferably mounted to the roof of the housing so that the outlet end of the tunnel forms, or is connected to, the outlet from the housing.

Preferably the recirculation damper is positioned across a recirculation opening in a wall of the exhaust tunnel. The recirculation damper is preferably configurable between an exhaust position, in which the recirculation damper closes the recirculation opening and does not impede airflow out of the outlet end of the tunnel, and an open position, in which the recirculation damper opens to direct air through the recirculation opening.

The ventilation system may comprise an inlet damper arranged across the air inlet. The inlet damper may preferably be a variable damper, and the position of the variable damper may preferably be continuously variable between open and closed. Preferably the position of the inlet damper is controllable by the controller.

The reversible fan may preferably be a variable speed fan, and the controller may preferably be configured to control both the direction and speed of the fan.

### Temperature Control

The ventilation system preferably comprises:
an outside temperature sensor for sensing a temperature of ambient air outside the livestock housing; and
an inside temperature sensor for sensing a temperature of air in the interior of the livestock housing;
in which the controller is configured to receive signals from the outside and inside temperature sensors, and to control the ventilation system to maintain the temperature of air in the interior of the livestock housing within a predetermined target temperature range.

The controller may be configured control the ventilation system to maintain the temperature of air in the interior of the livestock housing at a target temperature within a predetermined target temperature range. In preferred embodiments, the target temperature range may be a range of ±2° C. or ±1° C. around the target temperature. The controller may be programmed to maintain a target temperature of between 36° C. and 18° C. inside the housing, preferably between 34° C. and 20° C.

The predetermined target temperature range may be the thermal comfort zone of the livestock, as shown in FIG. 1 for example, or the predetermined target temperature range may be a narrower range within the thermal comfort zone. By monitoring inside and outside temperatures, the controller may advantageously control the ventilation system to provide air to the livestock housing at a target temperature within the target temperature range.

The controller preferably controls the temperature of the air inside the livestock housing by controlling the direction of the fan, and/or the speed of the fan, and/or the position of the recirculation damper and any other dampers in the system. The temperature of the air inside the livestock housing is determined by the temperature of the ambient air delivered into the housing, the fan speed and the resulting air flow rate through the housing, the amount of heat generated by the livestock in the housing, and whether or not heated air is recirculated or exhausted from the housing. By monitoring the temperature both outside and inside the housing, and controlling the fan speed and the extent to which heated air is recirculated, the controller may thus control the temperature of the air inside the livestock housing to match a target temperature within an acceptable temperature range.

The controller may control the temperature and/or relative humidity of the air in the interior of the livestock housing by controlling the rates of air flows of ambient air and optionally recirculated air recirculated through the recirculation damper. The controller may control the temperature and/or relative humidity of the air in the interior of the livestock housing by controlling the position of the recirculation damper, the position of the inlet damper, and the direction and speed of the fan.

### Humidity Control

The ventilation system may also comprise:
an outside relative humidity (RH) sensor for sensing a relative humidity of ambient air outside the livestock housing; and
an inside relative humidity sensor for sensing a relative humidity of air in the interior of the livestock housing;
in which the controller is configured to receive signals from the outside and inside relative humidity sensors, and to control the ventilation system to maintain the relative humidity of air in the interior of the livestock housing within a predetermined target relative humidity range.

Preferably the controller may be configured to control the ventilation system to maintain the relative humidity of air in the interior of the livestock housing below a maximum relative humidity. The maximum relative humidity may be a relative humidity level determined to be the maximum acceptable level for the livestock in the housing, and/or the maximum level at which ammonia levels do not exceed an acceptable limit. For example, the controller may be configured to maintain the relative humidity inside the livestock housing below a maximum relative humidity of 70%, or 65%, or 60%, or 55%. As high relative humidity is an important contributor to the problem of ammonia build-up, limiting the relative humidity in the housing is beneficial in reducing ammonia-related problems.

The controller may be programmed to increase the target temperature, or increase the range limits of the target temperature range of the air in the interior of the livestock housing, in order to reduce the relative humidity of the air in the interior of the livestock housing.

As the relative humidity of air depends on its temperature, increasing the temperature of air naturally reduces its relative humidity (though the specific humidity of the air does not change).

The controller may be programmed to increase the target temperature in response to signals from the outside and/or inside relative humidity sensors. For example the controller may be programmed to increase the target temperature in response to a signal from the inside relative humidity sensor that indicates the inside relative humidity is above the maximum relative humidity. Particularly preferably, the controller may be programmed to increase the target temperature in response to a signal from the inside relative humidity sensor that indicates the relative humidity inside the housing is above the maximum relative humidity of 60% RH.

Alternatively, the controller may be programmed to increase the target temperature in response to a signal from the outside relative humidity sensor that indicates the outside relative humidity is above the maximum relative humidity. If the ambient air that is being drawn into the housing from outside is itself above the maximum relative humidity, then the contribution of the livestock in the housing will mean that the humidity in the housing rises to unacceptably high levels. In such circumstances, the controller of the present invention may increase the target temperature so that the air delivered to the interior of the livestock housing has a lower relative humidity than would be the case at a lower target temperature.

The controller may adjust the target temperature, and thus the relative humidity, of the air delivered to the interior of the housing by varying the proportions in which incoming ambient air and recirculated air are delivered to the interior of the housing, or by turning on one or more heaters.

The controller may be programmed to increase the target temperature by 1° C. or 2° C. or 3° C. or 4° C. in order to reduce the relative humidity of the air in the housing. Each additional degree C. on the target temperature reduces the relative humidity of the air in the housing by around 5%.

For example, if the target temperature for the livestock inside the housing (with their current size and weight) is 20° C., but the ambient relative humidity is above the maximum relative humidity on a given day, then the controller may increase the target temperature by 2° C. to 22° C. The 2° C. increase in air temperature inside the housing will lead to a reduction of around 10% relative humidity in the air inside the housing, resulting in significant benefits for the comfort of the livestock.

Increasing the target temperature in order to reduce the relative humidity of the air in the housing is preferably a temporary measure, as it is undesirable for the livestock in the housing to be subjected to raised temperatures for prolonged periods. The present inventor has realised that in certain conditions, however, the benefits of reducing the relative humidity in the housing, and therefore reducing ammonia-related problems, can outweigh the downsides of a relatively small increase in the target temperature.

The controller may be programmed to increase the target temperature for a predetermined period. For example, in response to a signal from the outside relative humidity sensor that indicates the outside relative humidity is above the maximum relative humidity, the controller may increase the target temperature for a period of two hours, or four hours, or 6 hours, or 12 hours.

Alternatively, the controller may be programmed to increase the target temperature until the inside relative humidity sensor indicates that the inside relative humidity is below the maximum relative humidity for inside the housing. Once the inside air is below the maximum relative humidity, or has been below the maximum relative humidity for a predetermined period of time, the controller may reduce the target temperature to normal levels once more.

As the livestock in the livestock housing continually produce excreta which is mixed with the bedding on the floor of the housing, ventilation plays a vital role in evaporating liquid and reducing ammonia levels inside the housing. Ammonia is created when the nitrogen in, for example, poultry manure is broken down by bacteria. It impacts poultry bedding, litter and the overall air quality in chicken houses. The concentration of ammonia in poultry housing is exacerbated by environmental conditions, such as high temperatures and moisture, and can lead to pneumonia and respiratory problems in birds. Ammonia build-up is particularly problematic in prior art systems during winter months, if extract fans are turned off to reduce heating bills.

The present invention addresses the problem of ammonia build-up by providing a constant airflow around the housing at a controlled temperature and RH, which continually evaporates moisture and reduces the ammonia concentration. The improved airflow mixing provided in the present invention also means that this controlled airflow reaches all areas of the housing to evaporate moisture from the litter and prevent ammonia generation. This both improves the welfare of the livestock in the housing, and lessens the environmental impact of the ammonia smell on surrounding areas by preventing ammonia build-up and continually diluting the resulting odour.

By providing temperature and RH sensors both outside and inside the housing, the controller can advantageously control the ventilation system to control the RH of the air in the housing by controlling the direction of the fan, and/or the speed of the fan, and/or the position of the recirculation damper and any other dampers in the system.

The quality and particularly the moisture content of litter or bedding on the floor of the housing is of great importance to the comfort and welfare of the livestock in the housing. In particular, high moisture levels in the litter or bedding should be avoided. The ventilation system of the present invention is preferably configured to monitor the moisture level of the litter or bedding on the floor of the housing, and to control the ventilation system to maintain the litter moisture level below a maximum acceptable moisture level. The ventilation system can reduce litter moisture levels by providing a constant airflow over the litter at a controlled temperature and RH, so that the moisture in the litter is continuously evaporated. By increasing the temperature of the air in the housing, or decreasing its relative humidity (RH), the controller can increase evaporation of moisture from the litter.

In a preferred embodiment, the ventilation system may comprise one or more litter moisture meters configured to measure the moisture levels of the bedding, or litter, on the floor of the housing. The litter moisture meters may be provided on or in the floor of the housing, for example embedded in the floor of the housing. The ventilation system of the present invention is preferably configured to monitor the moisture level of the litter or bedding on the floor of the housing, and to control the ventilation system to maintain the litter moisture level below a maximum acceptable moisture level. In response to a signal from the litter moisture meter that indicates the litter moisture level has exceeded the maximum acceptable moisture level, the controller may be programmed to control the ventilation system to temporarily increase the temperature of the air in the housing, and/or decrease its relative humidity (RH) in order to encourage evaporation of moisture from the litter. The controller may be programmed to return to normal operation when the litter moisture meter indicates that the moisture level in the litter is once more below the maximum acceptable moisture level.

In a preferred embodiment, the ventilation system may comprise one or more litter temperature sensors configured to measure the temperature of the bedding, or litter, on the floor of the housing. The litter temperature sensors may be provided on or in the floor of the housing, for example embedded in the floor of the housing. The controller is preferably configured to receive a signal from the one or more litter temperature sensors, and to calculate the evaporation rate from the litter based on the temperature of the floor of the housing, and the temperature and relative humidity of the air in the housing. The temperature of the building floor structure has an effect on the evaporation of moisture from the litter. The controller is preferably configured to monitor the floor temperature and adjust the target air temperature to maintain a floor temperature which supports a desired litter evaporation rate.

The ventilation system may preferably comprise a water meter, or be configured to receive signals from a water meter, which indicates the quantity of water being provided to the housing as drinking water for the livestock. As almost all of the water supplied to the livestock housing as drinking water is eventually converted into moisture in the air, either through urination or evaporation from the livestock, the controller may be configured to receive signals from the water meter and to monitor the quantity of water supplied to the housing. The controller may be programmed to receive signals from the outside and inside relative humidity sensors and the water meter, and to control the ventilation system to maintain the relative humidity of air in the interior of the livestock housing within a predetermined target relative humidity range, and the litter moisture level below the maximum acceptable moisture level.

### Age & Weight Adjustment

Particularly preferably, the controller may be programmed to monitor the age or weight of livestock in the livestock housing, and to automatically adjust the predetermined target temperature range depending on the age or weight of the livestock housed in the livestock housing. For example, the controller may be programmed to adjust the predetermined target temperature range continuously as the livestock in the livestock housing grow older. Alternatively, the controller may be programmed to adjust the predetermined target temperature range at predetermined intervals, such as every day, or every week.

As discussed in the background section above, the temperature requirements of livestock such as broilers can vary significantly during their growth. While the crude prior art ventilation systems have allowed farmers to turn heaters on or off, and adjust the position of louvres on the air inlets, there has been little in the way of precise control in order to monitor and adjust the temperature inside the livestock housing.

In the ventilation system of the present invention, however, the controller may be programmed to regularly or continually adjust the target temperature range to a range that is appropriate for the age or weight of the livestock in the housing. Livestock such as broilers are typically housed in batches of broilers so that all of the broilers within a housing are the same age. The optimum inside air temperature of the housing will therefore change as the livestock grows older. So in a boiler house, the controller may be programmed to maintain the inside air temperature at around 34° C. (for example within a range of ±2° C. or ±1° C.) during an incubation period until the broilers have hatched, and then to continuously adjust the target temperature range to eventually reach a target air temperature of 20° C. (for example within a range of ±2° C. or ±1° C.) by the time that the broilers are 40 days old.

The controller may be programmed to maintain a target temperature of between 36° C. and 18° C. inside the housing, preferably between 34° C. and 20° C. Particularly preferably the controller may be programmed to adjust the target temperature from a temperature of between 32° C. and 36° C., preferably 34° C. (when eggs are placed in the housing, for example) to a temperature of between 18° C. and 22° C., preferably 20° C., after a set period. For broilers, the set period may be around 40 days, for example between 35 and 45 days.

By automatically adjusting the target temperature of the livestock housing according to the age or weight of the livestock, the temperature in the housing may be maintained at or very close to the optimum performance zone temperature, at which the livestock are most comfortable and the conversion of food to growth is maximised. This therefore improves the welfare of the livestock by maintaining comfortable conditions, and improves farming efficiency by providing a better food conversion yield.

### Cyclical Environmental Control

In the prior art, the temperature inside the livestock housing has typically been continuously maintained at a set temperature until a user adjusts the set temperature to a new level.

In a preferred embodiment of the present invention, the controller may be programmed to automatically adjust the target temperature, or the predetermined target temperature range, over a set period such as a 24 hour period.

In a first embodiment, the controller may be programmed to continuously adjust the target temperature throughout a 24 hour period, with the target temperature being varied according to the time of day. For example the target temperature of the interior of the livestock housing may be adjusted to be warmer during day time, and cooler during day time. This may advantageously reduce livestock stress by replicating a natural 24 hour temperature cycle, as would be experienced outside the artificial conditions of livestock housing. Particularly preferably, the controller may be programmed to adjust the target temperature in a sinusoidal pattern throughout the 24 hour period.

The controller may adjust the target temperature by ±0.2° C., ±0.5° C., ±0.75° C., ±1° C., or ±2° C., or ±3° C., or ±4° C., or ±5° C. during the 24 hour period. For example the target temperature at night may be 1° C., or 2° C., or 3° C., or 4° C., or 5° C. cooler than the target temperature in the middle of the day.

In a second embodiment, the controller may be programmed to continuously adjust the target temperature throughout a 24 hour period, with the target temperature being varied according to the metabolic rate of the livestock in the housing.

The controller is preferably programmed to maintain the interior of the housing at a target temperature at which the livestock are in “thermo-neutral” conditions in which the livestock are in their thermal comfort zone and are not losing energy due to being either too cold or too hot.

As shown in FIG. 15, the metabolic rate of the livestock typically varies cyclically over time in a roughly sinusoidal pattern. When the metabolic rate of the livestock is at its highest, the livestock is producing heat and has less need of external heating to reach thermo-neutral conditions. When the metabolic rate of the livestock is at its lowest, however, the temperature of the livestock drops, creating a greater need for external heating to maintain the livestock in a thermo-neutral temperature range.

The controller may be programmed to calculate the metabolic rate of the livestock by monitoring the feed and/or water intake of the livestock in the housing, and or by monitoring livestock activity based on CCTV footage from inside the housing.

In the present invention the controller may be programmed to adjust the target temperature in a cycle that is out of phase with the varying metabolic rate of the livestock in the housing. For example the controller may be programmed to adjust the target temperature in a sinusoidal cycle so that the target temperature is at its highest when the metabolic rate of the livestock is lowest, and the target temperature is at its lowest when the metabolic rate of the livestock is highest. This may advantageously maintain thermo-neutral conditions for the livestock throughout the day and night, rather than keeping the livestock at the same set temperature throughout the whole 24 hours. Maintaining thermo-neutral conditions throughout the day and night will advantageously increase the comfort of the livestock and improve food conversion efficiency.

The controller may adjust the target temperature by ±0.2° C., ±0.5° C., ±0.75° C., ±1° C., or ±2° C., or ±3° C., or ±4° C., or ±5° C. depending on the metabolic rate of the livestock.

A ventilation system may comprise a CO2 sensor configured to sense a CO2 concentration in the interior of the livestock housing, in which the controller is configured to receive signals from the CO2 sensor, and to control the ventilation system to maintain the CO2 concentration in the interior of the livestock housing to below a predetermined maximum concentration.

The controller may be programmed to respond to a signal that the CO2 concentration has exceeded the predetermined maximum concentration by operating the fan in the first airflow direction to direct a flow of air out of the outlet, and preferably by increasing the speed of the fan to increase the air flow out of the outlet.

The ventilation system may additionally comprise one or more evaporative coolers configured to evaporatively cool the stream of ambient air flowing through the air inlet, in which the controller is configured to control the one or more evaporative coolers, for example by controlling a water supply to the evaporative coolers. When water is supplied to the evaporative coolers to wet the evaporative cooling pads in the coolers, the flow of the stream of ambient air through the wet evaporative cooling pads causes the air to be evaporatively cooled.

Providing evaporative coolers for cooling the air that is delivered to the interior of the housing advantageously ensures that the ventilation system can continue to provide cooling air to the livestock housing even on extremely hot days, where the temperature of ambient air is too high to be delivered directly to the livestock housing. This may advantageously reduce the likelihood of heat stress for the livestock, particularly during summer months.

### Cooling Mode

When the ventilation system comprises an evaporative cooler, the controller may preferably be programmed to operate the ventilation system in a cooling mode, in which:
water is supplied to the evaporative cooler so that the evaporative cooler cools the stream of ambient air flowing through the air inlet into the interior of the livestock housing. In the cooling mode, the controller also preferably controls the fan to operate in the first airflow direction, so that the fan directs a flow of air out of the housing through the outlet.

The controller is preferably programmed to operate in the cooling mode in response to a signal from the outside temperature sensor that indicates the temperature of ambient air outside the livestock housing is above a predetermined maximum ambient temperature; and/or in response to a signal from the inside temperature sensor that indicates the temperature inside the livestock housing is above a predetermined maximum interior temperature. Either or both of these signals may confirm to the controller that the livestock housing requires additional cooling of the incoming ambient air in order to keep the interior of the housing at an acceptable temperature, and so may prompt the controller to activate the cooling mode.

### Ventilation Mode

The controller may additionally or alternatively be programmed to operate the ventilation system in a ventilation mode, in which a stream of ambient air is provided to the interior of the housing through the air inlet, and the fan operates in the first airflow direction, so that the fan directs a flow of air out of the housing through the outlet.

The controller may be programmed to operate in the ventilation mode in response to a signal from the outside temperature sensor that indicates the temperature of ambient air outside the livestock housing is above a predetermined minimum ambient temperature and below a predetermined maximum ambient temperature; and/or in response to a signal from the inside temperature sensor that indicates the temperature inside the livestock housing is within the predetermined target temperature range. If the ambient temperature is within the predetermined target temperature range, then ambient air may be delivered directly to the interior of the livestock housing without any need for either cooling or heating.

### Heating & Recirculation Mode

The ventilation system may additionally comprise a heater for heating air inside the livestock housing. Preferably the controller is configured to control the heater, and to turn the heater on or off as required. For example, the controller may be configured to turn off the heater in response to the inside temperature reaching a target temperature, or reaching the target temperature range, and/or to turn on the heater in response to the inside temperature falling below the target temperature range.

The controller may be programmed to operate the ventilation system in a heating and recirculation mode, in which:
the heater is turned on to heat air inside the livestock housing;
the recirculation damper is opened; and
the fan is controlled to operate in the second airflow direction, so that the fan directs heated air through the recirculation damper and back into the housing.

The controller is preferably programmed to operate in the heating and recirculation mode in response to a signal from the outside temperature sensor that indicates the temperature of ambient air outside the livestock housing is below a predetermined minimum ambient temperature; and/or in response to a signal from the inside temperature sensor that indicates the temperature inside the livestock housing is below a predetermined minimum interior temperature, or below the target temperature range.

Particularly preferably, the controller is programmed to operate the ventilation system in any one of the cooling, ventilation, or heating and recirculation modes, depending on the signals from the outside and/or inside temperature sensors. Depending on the ambient conditions and the conditions in the livestock housing, the ventilation system may therefore be operated in a plurality of different ways, in order to maintain the conditions in the housing within the target temperature range and/or relative humidity range. The controller may preferably be programmed to switch between control modes automatically in response to signals from the various sensors. This may advantageously ensure that desired conditions are always achieved inside the livestock housing, and also save energy by eliminating unnecessary heating or cooling of the air inside the livestock housing.

### Humidity Control Mode

When the relative humidity inside the housing is below a predetermined maximum relative humidity, which may preferably be set at 60% RH, the controller is preferably programmed to control the ventilation system to maintain the temperature of air in the interior of the livestock housing at a target temperature within a predetermined target temperature range. This may be called “temperature control mode”. In this mode, the controller may operate in whichever mode (cooling, ventilation, heating and recirculation, or a hybrid mode discussed below) maintains the temperature of air in the interior of the livestock housing at a target temperature, within a predetermined target temperature range.

When the relative humidity inside the housing exceeds the predetermined maximum relative humidity, however, the controller may be programmed to switch into a humidity control mode.

As discussed above, a particular problem with prior art livestock housings is that high relative humidity (RH) in the housing can cause a build-up of ammonia which can be detrimental to the welfare of livestock in the housing, and which creates an unpleasant odour in the surrounding area.

In preferred embodiments, the present invention can particularly address the issue of ammonia build-up by operating in a humidity control mode.

The controller may be programmed to operate in a humidity control mode, in which: the ventilation system delivers a flow of ambient air and a flow of recirculated air to the housing in controlled proportions or a controlled flow ratio so as to maintain the interior of the livestock housing below a maximum relative humidity.

In order to mix the flow of ambient air with a flow or recirculated air, the recirculation damper is opened, and the fan is controlled to operate in the second airflow direction, so that the fan directs heated air through the recirculation damper and back into the housing, where it mixes with the incoming ambient air inside the livestock housing. The cooler ambient air mixes with the heated recirculated air to create overall air conditions having a temperature between the temperature of the ambient air and the recirculated air, and a relative humidity between the RH of the ambient air and the recirculated air.

The maximum relative humidity may be a maximum relative humidity considered acceptable for the inside of the livestock housing, for example a relative humidity limit above which ammonia-related problems occur. For example, the controller may be configured to maintain the relative humidity inside the livestock housing below a maximum relative humidity of 70%, or 65%, or 60%, or 55%, or 50%. Particularly preferably, the maximum relative humidity inside the housing may be 60% RH.

Relative humidity control can be of particular importance on days on which the ambient air outside the housing has a high relative humidity. As the livestock inside the housing contribute to increasing humidity by perspiration and by evaporation of urine, when the incoming ambient air is also at a high humidity, the resulting relative humidity inside the housing can increase to unacceptable levels both for the comfort of the livestock and for ammonia-related problems which occur at high relative humidity.

The controller may preferably be programmed to operate in the humidity control mode when the outside specific humidity of ambient air is above the maximum relative humidity. For example, the controller may operate humidity control mode in response to a signal from the outside relative humidity sensor that indicates the outside relative humidity is above the maximum relative humidity. If the ambient air that is being drawn into the housing from outside is itself above the target relative humidity, then the contribution of the livestock in the housing will mean that the humidity in the housing rises to unacceptably high levels. In such circumstances, the controller of the present invention may increase the target temperature so that the air delivered to the interior of the livestock housing has a lower relative humidity than would be the case at a lower target temperature.

The controller may be programmed to operate in the humidity control mode when the inside specific humidity of ambient air is above the maximum relative humidity. For example, the controller may operate humidity control mode in response to a signal from the inside relative humidity sensor that indicates the relative humidity inside the housing is above the maximum relative humidity. Preferably the controller may be programmed to increase the target temperature in response to a signal from the inside relative humidity sensor that indicates the inside relative humidity is above the maximum relative humidity. Particularly preferably, the controller may be programmed to increase the target temperature in response to a signal from the inside relative humidity sensor that indicates the relative humidity inside the housing is above the maximum relative humidity of 60% RH.

The controller may be programmed to operate in the humidity control mode in response to a signal from an ammonia sensor indicating that the ammonia level inside the housing has exceeded a predetermined maximum ammonia concentration. For example the controller may be programmed to operate in the humidity control mode in response to a signal from an ammonia sensor indicating that the ammonia level inside the housing has exceeded a maximum ammonia concentration of 20 ppm. The ammonia concentration may preferably be measured at a height of 15 cm, or 20 cm, or 25 cm, or 30 cm above the floor of the housing.

The controller may be programmed to operate in the humidity control mode in response to a signal from a specific humidity sensor indicating that the specific humidity inside the housing has exceeded a predetermined maximum specific humidity.

In humidity control mode, the controller is preferably programmed to increase the target temperature of the air in the livestock housing, to reduce the relative humidity of the air in the interior of the livestock housing. As the relative humidity of air depends on its temperature, increasing the temperature of air naturally reduces its relative humidity (though the specific humidity of the air does not change).

The controller may be programmed to increase the target temperature by 1° C. or 2° C. or 3° C. or 4° C., or 5° C., or 6° C. in order to reduce the relative humidity of the air in the housing.

Each 1° C. increase in target temperature reduces the relative humidity of the air inside the housing by around 5%. By slightly increasing the temperature inside the housing, the relative humidity can therefore be significantly reduced.

The controller is preferably programmed to increase the target temperature to a temperature at which the air in the interior of the livestock housing is below the maximum relative humidity. Particularly preferably the controller may increase the target temperature to a temperature at which the air in the interior of the livestock housing is below the maximum relative humidity of 60% RH.

The controller may adjust the target temperature, and thus the relative humidity, of the air inside the housing by varying the proportions in which incoming ambient air and recirculated air are provided to the housing, for example by varying the fan speeds and dampers. Alternatively, the controller may increase the temperature of the air inside the housing by on one or more heaters.

Increasing temperatures inside livestock housings is typically avoided except when required in cold weather to keep the interior of the housing from dropping too low, as higher temperatures may both increase running costs (through increased power demands for heaters) and lower the food conversion yield of the livestock in the housing. The present inventor has appreciated, however, that operating in a humidity control mode which increases the target temperature to reduce relative humidity can advantageously provide significant benefits in drying litter and reducing urea volatilisation to ammonia, and therefore improving livestock welfare.

The lower the relative humidity of the air supply to the interior of the housing, the greater its capacity to evaporatively cool livestock in the housing. Many types of livestock are cooled by panting, which involves the evaporation of water from internal body surfaces. The efficiency of this cooling is greater when the air breathed in by the livestock is drier (has a lower relative humidity, and therefore a greater capacity to absorb water by evaporation). Thus slightly increasing the target temperature of the air in the housing to reduce its relative humidity may counterintuitively improve evaporative cooling of the livestock as well as evaporatively drying litter to reduce ammonia volatilisation. Together, these benefits may advantageously outweigh the downsides of housing the livestock at a temperature a few° C. higher than the normal target temperature.

Increasing the target temperature in order to reduce the relative humidity of the air in the housing is preferably a temporary measure, as it is undesirable for the livestock in the housing to be subjected to raised temperatures for prolonged periods. The present inventor has realised that in certain conditions, however, the benefits of reducing the relative humidity in the housing, and therefore reducing ammonia-related problems, can outweigh the downsides of a relatively small increase in the target temperature. The humidity control mode may thus be beneficial when ambient conditions are particularly humid.

The controller may be programmed to operate humidity control mode for a predetermined period, for example a predetermined period of time elapsing from a signal received from the outside humidity sensor which indicates that the outside specific humidity of ambient air is above the maximum relative humidity. Alternatively, the controller may be programmed to operate in humidity control mode until the outside relative humidity sensor indicates that the outside relative humidity is below the maximum relative humidity for inside the housing. Once the ambient air is below the maximum relative humidity, the controller may cease to operate in humidity control mode and return to temperature control mode, in which the controller aims to maintain the temperature inside the housing at the target temperature.

### Litter Moisture Control Mode

When the relative humidity inside the housing is below a predetermined maximum relative humidity, and the moisture level of the litter or bedding on the housing floor is below a maximum acceptable moisture level, the controller is preferably programmed to control the ventilation system to operate in “temperature control mode” or “humidity control mode”, as described above. In this mode, the controller may operate in whichever mode (cooling, ventilation, heating and recirculation, or a hybrid mode discussed below) maintains the temperature of air in the interior of the livestock housing at a target temperature, within a predetermined target temperature range.

When the moisture level in the litter on the floor of the housing exceeds the predetermined maximum acceptable moisture level, however, the controller may be programmed to switch into a litter moisture control mode.

As discussed above, a particular problem with prior art livestock housings is that high moisture levels in litter on the housing floor can cause health problems and discomfort for the livestock, and also lead to high relative humidity (RH) in the housing and a build-up of ammonia. Particularly in hot weather, damp litter will make livestock such as poultry much more uncomfortable than dry litter, as birds will attempt to dust bathe in the litter as a way of aiding cooling. Maintaining the litter at acceptably low moisture levels is therefore of great importance for livestock comfort in hot weather.

In preferred embodiments, the present invention can particularly address the issue of high litter moisture levels by operating in a litter moisture control mode.

The controller may be programmed to operate in a litter moisture control mode, in which: the ventilation system delivers a flow of ambient air and a flow of recirculated air to the housing in controlled proportions or a controlled flow ratio so as to reduce the moisture level of the litter to below a maximum acceptable moisture level.

The maximum acceptable moisture level for the litter or bedding may vary depending on the type of livestock being housed in the housing, and the type of litter or bedding on the floor of the housing.

The maximum acceptable moisture level may be between 30-70%. Alternatively, the maximum acceptable moisture level may be between 35% and 65%, or between 40% and 60%, or between 45% and 55%. For example the maximum acceptable moisture level may be 70%, or 65%, or 60%, or 55%, or 50%.

In order to mix the flow of ambient air with a flow or recirculated air, the recirculation damper is opened, and the fan is controlled to operate in the second airflow direction, so that the fan directs heated air through the recirculation damper and back into the housing, where it mixes with the incoming ambient air inside the livestock housing. The cooler ambient air mixes with the heated recirculated air to create overall air conditions having a temperature between the temperature of the ambient air and the recirculated air, and a relative humidity between the RH of the ambient air and the recirculated air.

The maximum acceptable moisture level for the litter may be a maximum acceptable moisture level considered acceptable for livestock welfare, for example a moisture limit above which ammonia-related problems occur. For example, the controller may be configured to maintain the litter moisture within a range of 30-70%.

As high litter moisture levels are so detrimental to livestock welfare, the controller may preferably be programmed to operate in the litter moisture control mode whenever it is sensed that the litter moisture level is above the maximum acceptable moisture level.

In litter moisture control mode, the controller controls the ventilation system in a way that evaporates excess moisture from the litter, so that the litter moisture level drops to a level below the maximum acceptable litter moisture level. In this mode, the controller may control the ventilation system to: increase the target temperature of the air inside the housing to increase evaporation from the litter; decrease the relative humidity of the air inside the housing to increase evaporation from the litter (as described above in relation to the humidity control mode); and/or increase the rate of airflow through the housing and over the litter to increase evaporation from the litter.

Increasing the target temperature in order to reduce the moisture level of the litter in the housing is preferably a temporary measure, as it is undesirable for the livestock in the housing to be subjected to raised temperatures for prolonged periods. The present inventor has realised that in certain conditions, however, the benefits of reducing the moisture level in the litter, and therefore reducing health and ammonia-related problems, can outweigh the downsides of a relatively small increase in the target temperature. The litter moisture control mode may thus be beneficial when the litter is particularly wet.

The controller may be configured to operate in litter moisture control mode until the moisture level of the litter is below the maximum acceptable moisture level, or alternatively to operate in litter moisture control mode for a set period. For example the controller may be programmed to operate the ventilation system in litter moisture control mode for a maximum period of 1 hour, or 2 hours, or 4 hours at a time before returning to temperature control mode.

### Livestock Stress

Stress experienced by livestock, in particular poultry, can be a cause of disease and infection. For example, increased stress during poultry production can result in poultry birds becoming infected with campylobacter, which does not commonly cause clinical disease in birds but is a significant cause of enteritis in humans.

In order to manage livestock stress levels, the controller of the ventilation system may advantageously be configured to monitor the temperature inside the housing, the relative humidity inside the housing, and the activity of the livestock in the housing. The controller may advantageously be programmed to calculate a livestock stress index (preferably a bird stress index) based on this temperature, humidity and activity data.

The controller is preferably programmed to calculate the stress index from the temperature and humidity using a range of formulae such as those produced by Mitchell and Kettlewell (Mitchell, M., & Kettlewell, P. (1998). Physiological stress and welfare of broiler chickens in transit: solutions not problems! Poultry Science, 77 (12), 1803-1814; Mitchell, M., & Kettlewell, P. (2009). Welfare of poultry during transportation-a review. Paper presented at the Poultry Welfare Symposium). Apparent Equivalent Temperature (AET) was calculated from dry bulb temperature (T_{db}, in ° C.), water vapor pressure and the psychrometric constant. It can also be calculated using dry bulb temperature and relative humidity alone as defined in equation (1) below (Mitchell and Kettlewell, Poultry Science 1998):

$$AET = {T}_{b} + \frac{{10}^{( 31.5905 - 8.2 * Log 10 ( {T}_{db} + 273 ) + 0.0024804 * ( {T}_{db} + 273 ) - \frac{3142.31}{( {T}_{db} + 273 )} )} * Φ}{0.93 * ( 0.0006363601 * ( {T}_{db} + 273 ) + 0.472 )} \qquad ( 1 )$$

where ϕ=observed relative humidity (RH, expressed as a decimal).

The controller may be configured to control the ventilation system to reduce the livestock stress index. For example, the controller may be configured to increase or decrease the target temperature, or increase or decrease the target relative humidity, in order to provide conditions inside the housing that will lead to a lower level of livestock stress. This may in turn improve livestock welfare and reduce incidences of disease and infection.

### Modular Ventilation of Bays

In a particularly preferred embodiment, the livestock housing is sub-divided into a plurality of bays, and the ventilation system comprises a plurality of bay ventilation systems for providing a stream of controlled-temperature air to each bay.

Each bay of the housing preferably comprises its own air inlet, outlet, reversible fan and recirculation damper. Each bay may additionally comprise an evaporative cooler arranged to cool ambient air entering the housing through the air inlet. The system preferably comprises a plurality of heaters.

A large livestock housing such as a chicken shed is conventionally heated and cooled by a single centrally-controlled ventilation system. As described above, however, shortcomings with the controllability and layout of the ventilation system has typically led to non-uniform temperatures and humidity throughout the housing, and wasted energy used to heat air that is immediately exhausted and replaced by incoming cold air. Furthermore, the use of large, centrally controlled heaters and unidirectional single-speed extract fans has meant that fine-control of the temperature in the housing has not been possible.

The present invention may advantageously comprise a plurality of bay ventilation systems operable as independent modules. Each independent module may provide an airflow to the interior of the livestock housing, so that mixing of the multiple airflows results in a net temperature and relative humidity in the housing. By providing multiple bay ventilation systems that can be operated independently of one another to provide airflows at different temperature and humidity conditions, the airflows may be mixed in the housing to create net air conditions that could not be provided by a single ventilation system.

The bays are preferably connected to one another, and configured so that air may flow between bays. There are preferably no walls between bays, so air is free to flow throughout the entire livestock housing.

The ventilation system may comprise mixing fans configured to direct air between adjacent bays, in order to improve mixing of the air in the livestock housing.

Each bay ventilation system is preferably a ventilation system according to the first aspect of the invention.

The ventilation system preferably comprises system controller responsive to a temperature and/or a humidity in the system space. The system controller is preferably configured to control the plurality of bay ventilation systems. Preferably the system controller may be operatively linked to the controllers of the bay ventilation systems, such that the system controller may control all of the bay ventilation systems according to a predetermined control protocol.

The system controller may control the plurality of bay ventilation systems to control an air temperature and/or humidity in the system space. Preferably the system controller may control the bay ventilation systems independently of one another to deliver air to the interior of the housing at a desired temperature and/or humidity. For example, the system controller may control one or more bay ventilation systems to operate in the same way, so that each bay receives air at the same temperature and humidity, or the system controller may control different bay ventilation systems to operate differently, so that different bays receive air flows of different temperatures and/or humidity and/or flow rates.

References to a system controller and bay ventilation system controllers may be taken as references to controller functionality rather than controller location. In a system comprising multiple bays and bay ventilation systems, all controller functions may, for example, be performed by the system controller, suitably programmed and connected to the fans, dampers, evaporative coolers and heaters of each bay.

The system controller may then advantageously control any fans, variable dampers and water supplies of the plurality of evaporative coolers. Particularly preferably the system controller may determine whether each bay ventilation system operates in cooling mode, ventilation mode, or heating and recirculation mode.

The system controller may be programmed to control the plurality of bay ventilation systems selectively either to operate in the same way as each other, or to operate in a hybrid mode in which some bay ventilation systems operate differently to others, so that different bay ventilation systems deliver air of different temperatures, humidities or flow rates.

The ability of the system controller to control, in use, the plurality of bay ventilation systems independently of one another may allow the overall system to deliver a desired net air flow to the livestock housing by combining a plurality of air flows delivered by different bay ventilation systems at different temperatures and/or humidity and/or flow rates. This may advantageously mean that the livestock housing can be maintained at desired temperature and humidity conditions over a much wider range of ambient temperature and humidity conditions. The mixing of different air flows may also advantageously ensure that temperature and humidity conditions are homogeneous throughout the housing, so that livestock experience the same comfortable conditions wherever in the housing they are positioned.

The system controller may be programmed to operate a hybrid heating mode in which a first plurality of bay ventilation systems are operated in a ventilation mode, and a second plurality of bay ventilation systems are operated in a heating and recirculation mode. The system controller may be programmed to operate the hybrid heating mode in response to a signal from the outside temperature sensor that the ambient temperature is below a target inside temperature. Preferably the system controller may be programmed to operate the hybrid heating mode in response to a signal from the outside temperature sensor that the ambient temperature is below the target temperature range, but above a predetermined heating temperature at which all bay ventilation systems should be operated in heating and recirculation mode.

The system controller may be programmed to operate a hybrid cooling mode in which a first plurality of bay ventilation systems are operated in a ventilation mode, and a second plurality of bay ventilation systems are operated in a cooling mode. The system controller may be programmed to operate the hybrid cooling mode in response to a signal from the outside temperature sensor that the ambient temperature is above the target temperature range for the interior of the housing. Preferably the system controller may be programmed to operate the hybrid cooling mode in response to a signal from the outside temperature sensor that the ambient temperature is above the target temperature range, but below a predetermined cooling temperature at which all bay ventilation systems should be operated in cooling mode.

The system controller may be programmed to operate the plurality of bay ventilation systems in ventilation mode when the ambient temperature is within a predetermined target temperature range for the interior of the livestock-housing.

### Sequential Bay Control

Particularly preferably, the system controller may be programmed to operate the plurality of bay ventilation systems in a sequential manner. The system controller may be programmed to sequentially vary the operating modes of the bay ventilation systems within the housing.

For example, the system controller may be programmed to operate a first bay ventilation system in a first mode for a set period, while the other bay ventilation systems in the housing operate in a second mode. At the end of the set period, the controller may switch the first bay ventilation system into the second mode, and operate a second bay ventilation system in the first mode for a second set period. At the end of the second set period, the controller may switch the second bay ventilation system into the second mode, and operate a third bay ventilation system in the first mode for a third set period, and so on.

In a preferred embodiment, for example, depending on how much ventilation is required to reach the target temperature and/or relative humidity in the housing, the system controller may operate a first set (either one, or a plurality, depending on the airflow required by the housing) of bay ventilation systems in ventilation mode for a first set period, and then to operate a second set of bay ventilation systems in ventilation mode for a second set period. The controller may operate the bay ventilation systems to operate sequentially in ventilation mode, before returning to the beginning of the sequence and operating the first set of bay ventilation systems in ventilation mode again. The bays not operating in ventilation mode at any given time may be operating, for example, in recirculation mode, to mix the air within the housing.

Instead of ventilation mode, the bay ventilation systems may alternatively be operated sequentially in heating, recirculation, cooling, or any other modes described herein.

The set period may be set by a user, or programmed into the system controller, so that the air in the interior of the housing is replaced at a desired rate.

In prior art systems, when only a low level of ventilation is required to reach the desired temperature, typically a proportion of the air supplies may be turned off, and incoming air is supplied through an inlet typically positioned near the centre of the building. As livestock housings can be very large, however, this can lead to very uneven conditions with the centre of the housing being much better ventilated than the ends of the building distant from the air supply.

By operating different bay ventilation systems in a sequential manner, the present invention can ensure that air supplied into the livestock housing is mixed more evenly throughout the housing. This means that litter is dried throughout the housing, and that livestock positioned near the ends of the housing experience the same climatic conditions as those in the centre.

The ventilation system may be provided on a large variety of livestock housings. In particularly preferred embodiments, the livestock housing may be a fowl-housing ventilation system, or preferably a chicken-housing ventilation system.

In a second aspect of the present invention there is provided a livestock-housing, comprising a livestock-housing ventilation system according to the first aspect of the invention.

Features described above in relation to the first aspect of the invention are equally applicable to the livestock housing of the second aspect of the invention.

### Controller

According to a third aspect of the present invention there is provided a controller for a livestock-housing ventilation system for delivering air to the interior of livestock housing, in which the ventilation system comprises:
a first air inlet arranged to provide a stream of ambient air to the interior of the housing;
an outlet for air to be exhausted out of the housing;
a reversible fan configurable to operate in a first airflow direction, in which the fan directs a flow of air from the housing towards the outlet, or a second airflow direction, in which the fan directs air away from the outlet and into the housing; and
a recirculation damper arranged between the reversible fan and the outlet;
in which the controller is configured to control the fan.

The controller is preferably configured to control the temperature and/or relative humidity and/or flow rate of the air inside the housing. The controller is programmed to control these parameters by controlling the direction and optionally speed of the fan, and optionally the position of the recirculation damper.

The controller is preferably configured to control the fan to operate either in the first airflow direction or the second airflow direction. The controller is preferably configured to control the speed of the fan.

The controller may be configured to control a closable outlet damper arranged across the outlet, in which the outlet damper and the recirculation damper are configurable between an exhaust position, in which the outlet damper is open and the recirculation damper does not impede airflow out of the outlet, and a recirculation position, in which the outlet damper closes, or partially closes, the outlet and the recirculation damper opens so to direct a stream of air back into the interior of the housing.

The controller may be configured to receive signals from:
an outside temperature sensor for sensing a temperature of ambient air outside the livestock housing; and
an inside temperature sensor for sensing a temperature of air in the interior of the livestock housing;
in which the controller is configured to control the ventilation system to maintain the temperature of air in the interior of the livestock housing within a predetermined target temperature range.

In a particularly preferred embodiment, the controller is programmed to monitor the age or weight of livestock and to automatically adjust the predetermined target temperature range depending on the age of the livestock housed in the livestock housing. The controller may be programmed to adjust the predetermined target temperature range continuously, or every day, or every week.

In a preferred embodiment of the present invention, the controller may be programmed to automatically adjust the target temperature, or the predetermined target temperature range, over a set period such as a 24 hour period.

In a first embodiment, the controller may be programmed to continuously adjust the target temperature throughout a 24 hour period, with the target temperature being varied according to the time of day. For example the target temperature of the interior of the livestock housing may be adjusted to be warmer during day time, and cooler during day time. This may advantageously reduce livestock stress by replicating a natural 24 hour temperature cycle, as would be experienced outside the artificial conditions of livestock housing. Particularly preferably, the controller may be programmed to adjust the target temperature in a sinusoidal pattern throughout the 24 hour period.

The controller may adjust the target temperature by ±0.2° C., ±0.5° C., ±0.75° C., ±1° C., or ±2° C., or ±3° C., or ±4° C., or ±5° C. during the 24 hour period. For example the target temperature at night may be 1° C., or 2° C., or 3° C., or 4° C., or 5° C. cooler than the target temperature in the middle of the day.

In a second embodiment, the controller may be programmed to continuously adjust the target temperature throughout a 24 hour period, with the target temperature being varied according to the metabolic rate of the livestock in the housing.

The controller is preferably programmed to maintain the interior of the housing at a target temperature at which the livestock are in “thermo-neutral” conditions in which the livestock are in their thermal comfort zone and are not losing energy due to being either too cold or too hot.

As shown in FIG. 15, the metabolic rate of the livestock typically varies cyclically over time in a roughly sinusoidal pattern. When the metabolic rate of the livestock is at its highest, the livestock is producing heat and has less need of external heating to reach thermo-neutral conditions. When the metabolic rate of the livestock is at its lowest, however, the temperature of the livestock drops, creating a greater need for external heating to maintain the livestock in a thermo-neutral temperature range.

The controller may be programmed to calculate the metabolic rate of the livestock by monitoring the feed and/or water intake of the livestock in the housing, and or by monitoring livestock activity based on CCTV footage from inside the housing.

In the present invention the controller may be programmed to adjust the target temperature in a cycle that is out of phase with the varying metabolic rate of the livestock in the housing. For example the controller may be programmed to adjust the target temperature in a sinusoidal cycle so that the target temperature is at its highest when the metabolic rate of the livestock is lowest, and the target temperature is at its lowest when the metabolic rate of the livestock is highest. This may advantageously maintain thermo-neutral conditions for the livestock throughout the day and night, rather than keeping the livestock at the same set temperature throughout the whole 24 hours. Maintaining thermo-neutral conditions throughout the day and night will advantageously increase the comfort of the livestock and improve food conversion efficiency.

The controller may adjust the target temperature by ±0.2° C., ±0.5° C., ±0.75° C., ±1° C., or ±2° C., or ±3° C., or ±4° C., or ±5° C. depending on the metabolic rate of the livestock.

The ventilation system may additionally comprise an evaporative cooler configured to evaporatively cool the stream of ambient air flowing through the first inlet, and the controller may be configured to control the evaporative cooler, for example by controlling a water supply to the evaporative cooler.

The controller may be programmed to operate the ventilation system in a cooling mode, in which: water is supplied to the evaporative cooler so that the evaporative cooler cools the stream of ambient air flowing through the first inlet into the interior of the livestock housing; and the fan operates in a first airflow direction, so that the fan directs a flow of air out of the housing through the outlet.

The controller may be programmed to operate in the cooling mode in response to a signal from the outside temperature sensor that indicates the temperature of ambient air outside the livestock housing is above a predetermined maximum ambient temperature; and/or in response to a signal from the inside temperature sensor that indicates the temperature inside the livestock housing is above a predetermined maximum interior temperature.

The controller may be programmed to operate the ventilation system in a ventilation mode, in which: a stream of ambient air is provided to the interior of the housing through the first inlet; and the fan operates in a first airflow direction, so that the fan directs a flow of air out of the housing through the outlet.

The controller may be programmed to operate in the ventilation mode in response to a signal from the outside temperature sensor that indicates the temperature of ambient air outside the livestock housing is above a predetermined minimum ambient temperature and below a predetermined maximum ambient temperature; and/or in response to a signal from the inside temperature sensor that indicates the temperature inside the livestock housing is within the predetermined target temperature range.

The controller may be configured to control a heater for heating air in the livestock housing, for example by turning the heater on or off when necessary.

The controller may be programmed to operate the ventilation system in a heating and recirculation mode, in which:
the heater is turned on to heat air inside the livestock housing;
the recirculation damper is opened; and
the fan is controlled to operate in the second airflow direction, so that the fan directs heated air through the recirculation damper and back into the housing.

The controller may be programmed to operate in the heating and recirculation mode in response to a signal from the outside temperature sensor that indicates the temperature of ambient air outside the livestock housing is below a predetermined minimum ambient temperature; and/or in response to a signal from the inside temperature sensor that indicates the temperature inside the livestock housing is below a predetermined minimum interior temperature.

The controller may be configured to receive signals from an outside relative humidity sensor for sensing a relative humidity of ambient air outside the livestock housing; and/or an inside relative humidity sensor for sensing a relative humidity of air in the interior of the livestock housing. The controller may be configured to control the ventilation system to maintain the relative humidity of air in the interior of the livestock housing within a predetermined target relative humidity range.

The controller may be programmed to operate in a humidity control mode, in which:
the ventilation system delivers a flow of ambient air and a flow of recirculated air to the housing in controlled proportions or a controlled flow ratio so as to maintain the interior of the livestock housing below a maximum relative humidity. The controller may be programmed to operate in the humidity control mode when the specific humidity inside the housing is above the maximum relative humidity, preferably in which the maximum relative humidity is 60% relative humidity.

In the humidity control mode the controller may be programmed to increase the target temperature to a temperature at which the air in the interior of the livestock housing is below the maximum relative humidity.

The controller may be configured to receive signals from one or more litter moisture meters configured to measure the moisture levels of the bedding, or litter, on the floor of the housing. The controller may be configured for an operator to enter moisture levels from independent instrumentation, for example moisture levels measured using a hand-held moisture meter.

The controller may be configured to receive signals from one or more litter temperature sensors configured to measure the temperature of the bedding, or litter, on the floor of the housing.

The controller may be configured to receive signals from a water meter, which indicate the quantity of water being provided to the housing as drinking water for the livestock.

The controller may be programmed to receive signals from the outside and inside relative humidity sensors and/or the water meter, and to control the ventilation system to maintain the relative humidity of air in the interior of the livestock housing within a predetermined target relative humidity range, and the litter moisture level below a maximum acceptable moisture level.

The controller may be programmed to operate in a litter moisture control mode when the moisture level in the litter on the floor of the housing exceeds a predetermined maximum acceptable moisture level, in which:

the ventilation system delivers a flow of ambient air and a flow of recirculated air to the housing in controlled proportions or a controlled flow ratio so as to maintain the interior of the livestock housing below a maximum relative humidity.

In litter moisture control mode the controller may be programmed to control the ventilation system to: increase the target temperature of the air inside the housing to increase evaporation from the litter; decrease the relative humidity of the air inside the housing to increase evaporation from the litter; and/or increase the rate of airflow through the housing and over the litter to increase evaporation from the litter.

The controller may be configured to maintain the litter moisture level below a in a range of 30-70%

The controller may be programmed to monitor the temperature inside the housing, the relative humidity inside the housing, and the activity of the livestock in the housing, and to calculate a livestock stress index based on the monitored factors. Stress levels are typically reported as an ‘apparent’ or ‘effective’ temperature or as a simple stress index as described above.

The controller may be configured to increase or decrease the target temperature, or increase or decrease the target relative humidity, in order to provide conditions inside the housing that will lower the livestock stress index.

The controller is preferably configured to receive signals from the sensors in the ventilation system, and to select a mode of operation based on those signals. The controller may be programmed to prioritise operation modes in an order determined by the welfare of the livestock in the housing. For example, the controller may be programmed to operate in temperature control mode unless the relative humidity inside the housing exceeds the predetermined maximum relative humidity, and then to switch into a humidity control mode. The controller may be programmed to operate in temperature control mode unless the litter moisture level exceeds the maximum acceptable litter moisture level, and then to switch into a litter moisture control mode.

In a particularly preferred embodiment, the livestock housing is sub-divided into a plurality of bays, and the ventilation system comprises a plurality of bay ventilation systems for providing a stream of controlled-temperature air to each bay. A system controller, or a controller, is preferably configured to control the plurality of bay ventilation systems.

The system controller is programmed to control the plurality of bay ventilation systems selectively either to operate in the same way as each other, or to operate in a hybrid mode in which some bay ventilation systems operate differently to others, so that different bay ventilation systems deliver air of different temperatures, humidities or flow rates.

The system controller may be programmed to operate a hybrid heating mode in which a first plurality of bay ventilation systems are operated in a ventilation mode, and a second plurality of bay ventilation systems are operated in a heating and recirculation mode. For example, the system controller may be programmed to operate a hybrid heating mode in response to a signal from the outside temperature sensor that the ambient temperature is below a target inside temperature.

The system controller may be programmed to operate the plurality of bay ventilation systems in ventilation mode when the ambient temperature is within a predetermined target temperature range for the interior of the livestock-housing.

The system controller may be programmed to operate a hybrid cooling mode in which a first plurality of bay ventilation systems are operated in a ventilation mode, and a second plurality of bay ventilation systems are operated in a cooling mode.

The system controller may be programmed to operate a hybrid ventilation mode in which a first plurality of bay ventilation systems are operated in a ventilation mode, and a second plurality of bay ventilation systems are operated in a recirculation mode, to mix air within the housing.

Particularly preferably, the system controller may be programmed to operate the plurality of bay ventilation systems in a sequential manner. The system controller may be programmed to sequentially vary the operating modes of the bay ventilation systems within the housing.

For example, the system controller may be programmed to operate a first bay ventilation system in a first mode for a set period, while the other bay ventilation systems in the housing operate in a second mode. At the end of the set period, the controller may switch the first bay ventilation system into the second mode, and operate a second bay ventilation system in the first mode for a second set period. At the end of the second set period, the controller may switch the second bay ventilation system into the second mode, and operate a third bay ventilation system in the first mode for a third set period, and so on.

The controller and the system controller may be a controller or system controller as described above in relation to the first and second aspects of the invention. Features described herein in relation to a particular aspect of the invention are equally applicable to the other aspects of the invention unless indicated otherwise.

### Plant-Housing Ventilation System

According to a fourth aspect of the present invention there is provided a plant-housing ventilation system for providing a stream of controlled-temperature air to the interior of a plant housing, such as a greenhouse, hot-house, plant nursery or plant-cultivation building. The present invention may advantageously be applicable to any building or structure used to house plants, for example for housing plants during at least part of their growing process. The present invention may be particularly suitable for buildings used to house plants that are being cultivated outside their native regions, for example where plants native to tropical climates are being grown in countries with colder climates. Such plants may not be able to be successfully grown outdoors, at least during large portions of the year, and so may be grown indoors in plant-housing buildings.

The plant-housing ventilation system comprises:
an air inlet arranged to provide a stream of ambient air to the interior of the housing;
an outlet for air to be exhausted out of the housing;
a reversible fan configurable to operate in a first airflow direction, in which the fan directs a flow of air from the housing towards the outlet, or a second airflow direction, in which the fan directs air away from the outlet and into the housing;
a recirculation damper arranged between the reversible fan and the outlet; and
a controller for controlling the fan.

The plant-housing ventilation system is preferably configured to control the temperature and relative humidity of air inside the plant housing. The plant-housing ventilation system may be suitable for providing a stream of controlled-temperature and controlled-humidity air to the interior of plant housing.

The reversible fan can operate in either a first airflow direction, in which the fan directs a flow of air from the housing towards the outlet, or the fan can operate in a second airflow direction in which the fan directs air in the opposite direction, so that it flows away from the outlet and into the housing. This reversible fan is controllable by the controller, and allows the system to direct airflows in different directions within the interior of the plant housing, which creates more flexibility in how airflows are mixed.

The outlet is preferably positioned in a roof or ceiling of the housing, and the reversible fan is preferably positioned in the housing and arranged to direct air upwards out of the outlet in the first airflow direction, or downwards in the second airflow direction. In the second airflow direction, the fan can therefore direct air towards the floor of the plant housing, where the plants are located. Directing an airflow downwards with the reversible fan may advantageously cause that airflow to mix with the air in the housing and the airflow flowing into the housing through the air inlet, to create more uniform air conditions throughout the housing.

The presence of a recirculation damper between the reversible fan and the outlet also significantly increases the capabilities of the ventilation system compared to the simple “outlet and extract fan” arrangement of the prior art. By operating the fan in the second airflow direction and opening this recirculation damper, it is advantageously possible for the fan to draw an airflow of recirculated air through the recirculation damper and to direct it into the housing, for example downwards towards the floor of the housing. When the weather is cold and heating is required, for example, this means that heated air can be recirculated through the housing to create more uniform temperature and humidity conditions for plants throughout the housing. This may also significantly decrease the energy consumption of the heating system, as heated air may be recirculated rather than constantly exhausted and replaced by cold incoming ambient air.

The present invention therefore has the particular advantages of: creating and maintaining homogenous air conditions in the plant housing to both optimise the growth conditions of plants; and reducing the energy use of extract fans and heating systems used in prior art designs.

The plant housing may comprise two end walls, two side walls, a roof and a floor. Plants are typically positioned on the floor of the plant housing, floating in water troughs, or on racks in the housing.

The air inlet may be provided in a wall of the housing, for example in a side wall. The outlet may preferably be provided in the roof of the housing.

Preferably the housing may comprise a plurality of air inlets, a plurality of outlets, and a plurality of reversible fans and recirculation dampers corresponding to the plurality of outlets. The controller may preferably be programmed to control all of the plurality of fans and/or recirculation dampers.

The ventilation system may additionally comprise a closable outlet damper arranged across the outlet.

The outlet damper and the recirculation damper are preferably configurable between an exhaust position, in which the outlet damper is open and the recirculation damper does not impede airflow out of the outlet, and a recirculation position, in which the outlet damper closes, or partially closes, the outlet and the recirculation damper opens so to direct a stream of air back into the interior of the housing.

In the exhaust position, the recirculation damper is preferably closed, and the outlet damper is open. The controller is preferably programmed to operate the fan in the first airflow direction when the outlet and recirculation dampers are in the exhaust position, so that the fan directs air out of the housing through the outlet.

In the recirculation position, the recirculation damper opens, and the outlet damper either closes completely or closes partially. The controller is preferably programmed to operate the fan in the second airflow direction when the outlet and recirculation dampers are in the exhaust position, so that the fan draws air through the open recirculation damper and directs air into the housing and away from the outlet. Preferably the outlet is positioned in a roof or ceiling of the housing, and in the second airflow direction the fan directs air downwards into the housing.

The recirculation damper and/or the outlet damper may be controllable by the controller, so that the controller can control the position of the dampers between the recirculation position and the exhaust position. Alternatively, the recirculation damper and/or the outlet damper may be configured to move between the exhaust and recirculation positions in response to a pressure change resulting from a change of direction of the reversible fan.

In a preferred embodiment, the system comprises an exhaust tunnel, the exhaust tunnel having an inlet end arranged to receive air from the interior of the housing, and an outlet end arranged at the outlet from the housing. The reversible fan is preferably positioned in the exhaust tunnel and configured to direct air in the first airflow direction towards the outlet end of the tunnel, or to direct air in the second airflow direction towards the inlet end of the tunnel. Where the outlet is provided in a roof of the housing, the exhaust tunnel is preferably mounted to the roof of the housing so that the outlet end of the tunnel forms, or is connected to, the outlet from the housing.

Preferably the recirculation damper is positioned across a recirculation opening in a wall of the exhaust tunnel. The recirculation damper is preferably configurable between an exhaust position, in which the recirculation damper closes the recirculation opening and does not impede airflow out of the outlet end of the tunnel, and an open position, in which the recirculation damper opens to direct air through the recirculation opening.

The ventilation system may comprise an inlet damper arranged across the air inlet. The inlet damper may preferably be a variable damper, and the position of the variable damper may preferably be continuously variable between open and closed. Preferably the position of the inlet damper is controllable by the controller.

The reversible fan may preferably be a variable speed fan, and the controller may preferably be configured to control both the direction and speed of the fan.

The ventilation system preferably comprises:
an outside temperature sensor for sensing a temperature of ambient air outside the plant housing; and
an inside temperature sensor for sensing a temperature of air in the interior of the plant housing;
in which the controller is configured to receive signals from the outside and inside temperature sensors, and to control the ventilation system to maintain the temperature of air in the interior of the plant housing within a predetermined target temperature range.

The predetermined target temperature range may be the thermal range at which the plants grow best, or the predetermined target temperature range may be a narrower range within that thermal range. By monitoring inside and outside temperatures, the controller may advantageously control the ventilation system to provide air to the plant housing at a temperature within the target temperature range.

The controller preferably controls the temperature of the air inside the plant housing by controlling the direction of the fan, and/or the speed of the fan, and/or the position of the recirculation damper and any other dampers in the system.

The ventilation system may also comprise:
an outside relative humidity (RH) sensor for sensing a relative humidity of ambient air outside the plant housing; and
an inside relative humidity sensor for sensing a relative humidity of air in the interior of the plant housing;
in which the controller is configured to receive signals from the outside and inside relative humidity sensors, and to control the ventilation system to maintain the relative humidity of air in the interior of the plant housing within a predetermined target relative humidity range.

The correct humidity can be particularly important for plant cultivation, particularly for plants from tropical climates. Controlling the relative humidity in the plant housing is therefore key to the success of many types of plants.

By providing temperature and RH sensors both outside and inside the housing, the controller can advantageously control the ventilation system to control the RH of the air in the housing by controlling the direction of the fan, and/or the speed of the fan, and/or the position of the recirculation damper and any other dampers in the system.

Particularly preferably, the controller may be programmed to monitor the age or size of the plants in the plant housing, and to automatically adjust the predetermined target temperature range depending on the age or size of the plants housed in the plant housing. For example, the controller may be programmed to adjust the predetermined target temperature range continuously as the plants in the plant housing develop and grow. Alternatively, the controller may be programmed to adjust the predetermined target temperature range at predetermined intervals, such as every day, or every week.

The ventilation system may additionally comprise one or more evaporative coolers configured to evaporatively cool the stream of ambient air flowing through the air inlet, in which the controller is configured to control the one or more evaporative coolers, for example by controlling a water supply to the evaporative coolers. When water is supplied to the evaporative coolers to wet the evaporative cooling pads in the coolers, the flow of the stream of ambient air through the wet evaporative cooling pads causes the air to be evaporatively cooled.

The ventilation system is preferably operable in cooling, ventilation and/or heating and recirculation modes, as described above in relation to the first aspect of the invention.

Particularly preferably, the controller is programmed to operate the ventilation system in any one of the cooling, ventilation, heating and recirculation, or humidity control modes, depending on the signals from the outside and/or inside temperature sensors. Depending on the ambient conditions and the conditions in the plant housing, the ventilation system may therefore be operated in a plurality of different ways, in order to maintain the conditions in the housing within the target temperature range and/or relative humidity range that best suits the plants. The controller may preferably be programmed to switch between control modes automatically in response to signals from the various sensors. This may advantageously avoid problems like overheating or frost, which could damage the plants, and ensure that desired conditions are always achieved inside the plant housing. This may also save energy by eliminating unnecessary heating or cooling of the air inside the plant housing.

In a preferred embodiment, the plant housing may be sub-divided into a plurality of bays, and the ventilation system may comprise a plurality of bay ventilation systems as described above in relation to the first aspect of the invention.

According to a fifth aspect of the present invention there is provided a plant-housing, such as a greenhouse, hot-house, plant nursery or plant-cultivation warehouse, comprising a plant-housing ventilation system according to the fourth aspect of the invention.

According to a sixth aspect of the invention there is provided a controller for a plant-housing. The controller may have any of the features described above in relation to the third or fourth aspects of the invention.

### DESCRIPTION OF SPECIFIC EMBODIMENTS OF THE INVENTION

Specific embodiments of the invention will now be described, by way of example, with reference to the accompanying drawings, in which:

FIG. 1 is a schematic diagram illustrating the Optimum performance temperature zone for livestock;

FIG. 2 is a schematic cross-section of a broiler house with a prior art ventilation system;

FIG. 3 illustrates the prior art broiler house and ventilation system of FIG. 2, with the ventilation system operating in a heating mode;

FIG. 4 illustrates the prior art broiler house and ventilation system of FIG. 2, with the ventilation system operating in a cooling mode;

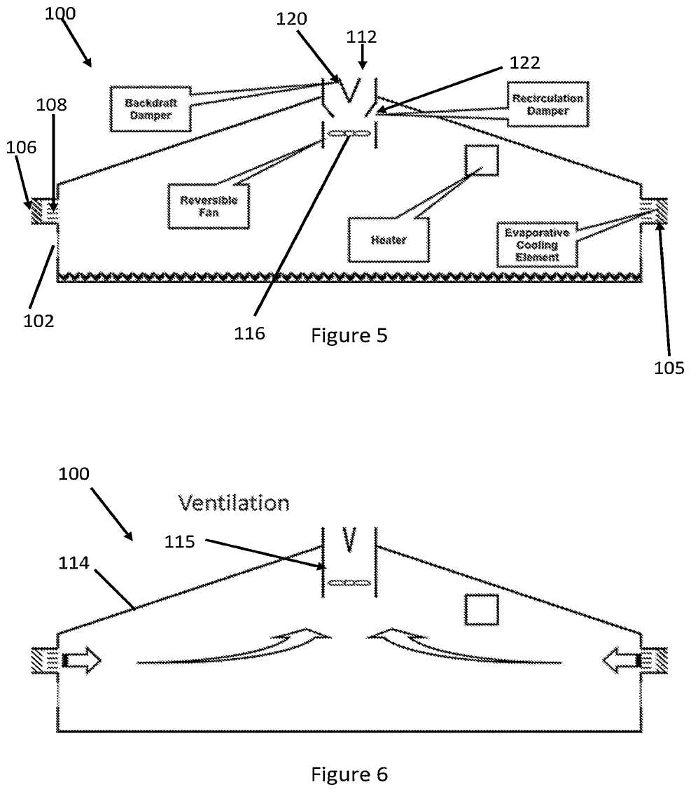

FIG. 5 is a schematic cross-section of a broiler house with a ventilation system according to the present invention;

FIG. 6 illustrates the broiler house and ventilation system of FIG. 5, with the ventilation system operating in a ventilation mode;

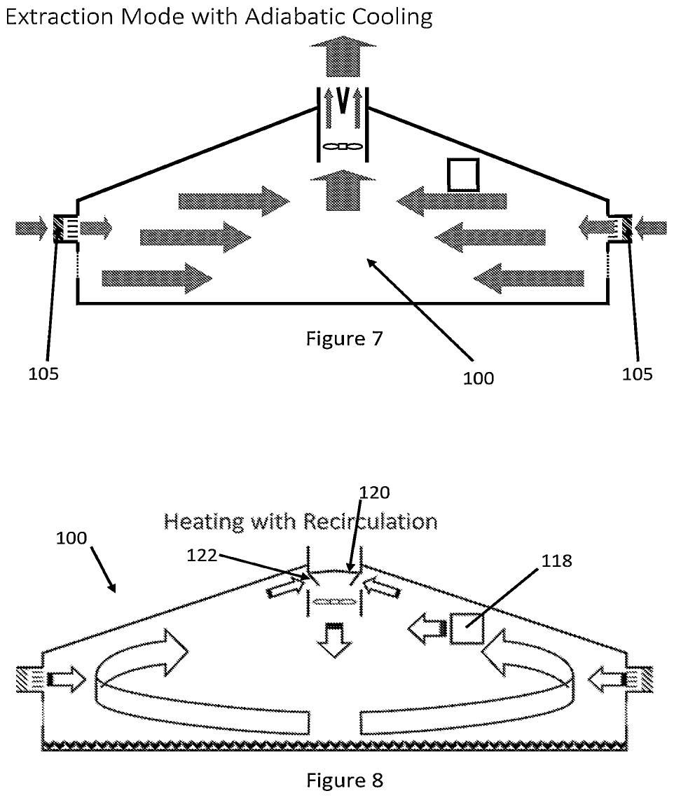

FIG. 7 illustrates the broiler house and ventilation system of FIG. 5, with the ventilation system operating in a cooling mode;

FIG. 8 illustrates the broiler house and ventilation system of FIG. 5, with the ventilation system operating in a heating with recirculation mode;

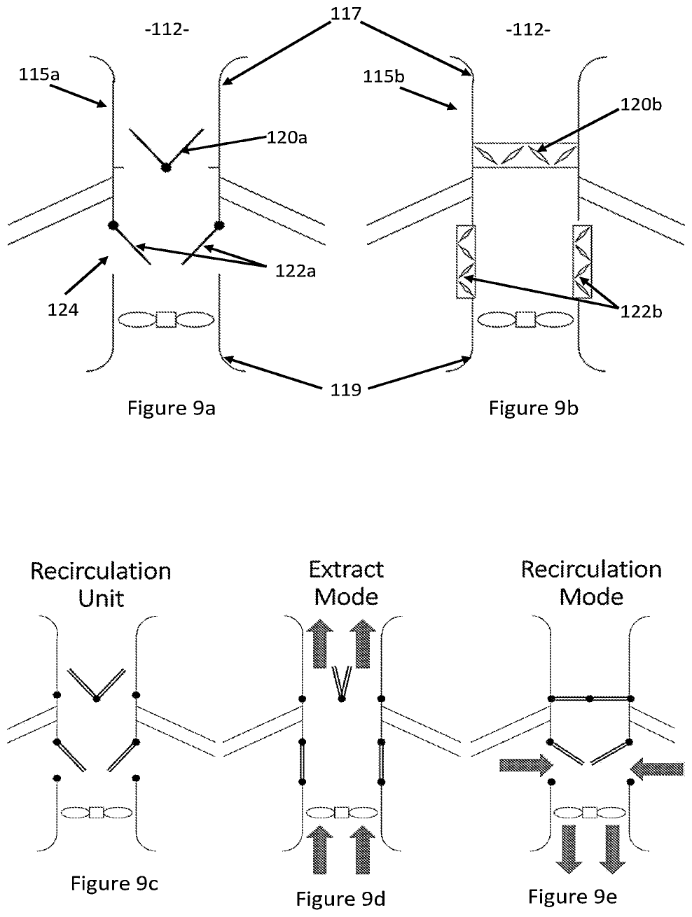

FIG. 9a is a schematic side-on cross section of a first embodiment of an exhaust tunnel usable in the present invention;

FIG. 9b is a schematic side-on cross section of a second embodiment of an exhaust tunnel usable in the present invention;

FIG. 9c is a schematic illustration of an exhaust tunnel usable in the present invention;

FIG. 9d is a schematic illustration of the exhaust tunnel of FIG. 9c operating in an extract mode;

FIG. 9e is a schematic illustration of the exhaust tunnel of FIG. 9c operating in a recirculation mode;

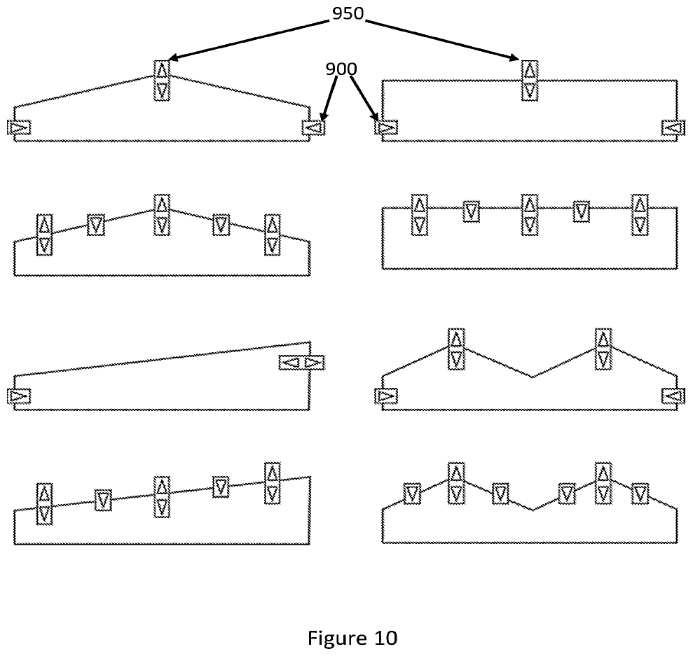

FIG. 10 illustrates schematic cross-sections of eight differently configured housings each comprising one or more air inlets and one or more reversible fans according to an aspect of the present invention;

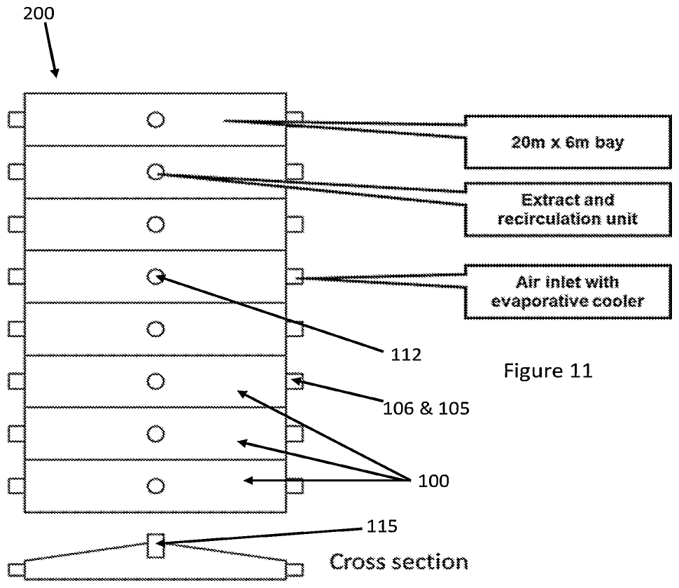

FIG. 11 is a schematic plan view and end-on cross-section of a livestock housing comprising a ventilation system according to an embodiment of the present invention;

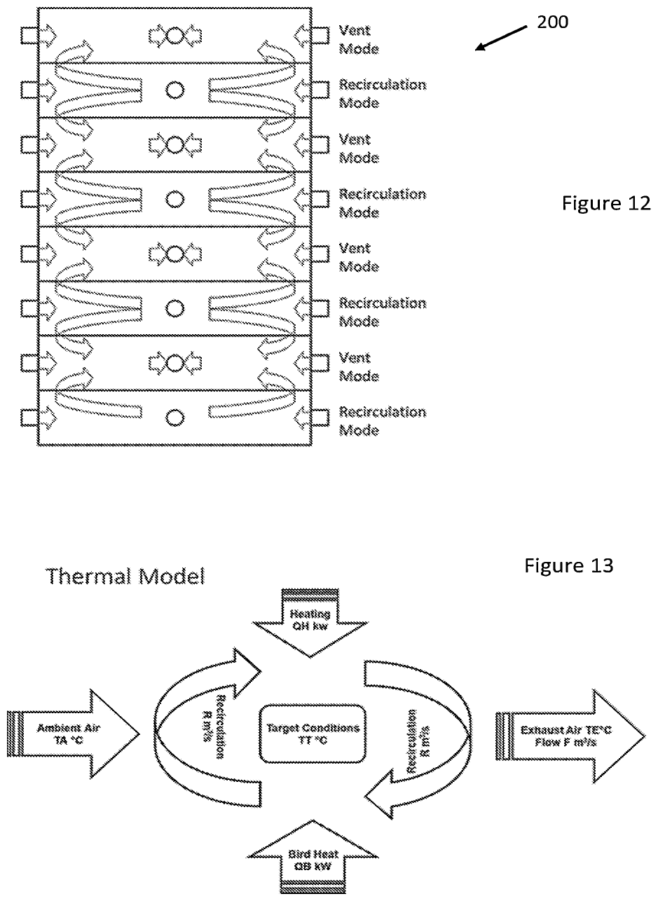

FIG. 12 is a schematic plan view showing the livestock housing ventilation system of FIG. 11 operating in a hybrid heating mode;

FIG. 13 illustrates a thermal model of a broiler house, usable by the controller of a ventilation system according to the present invention;

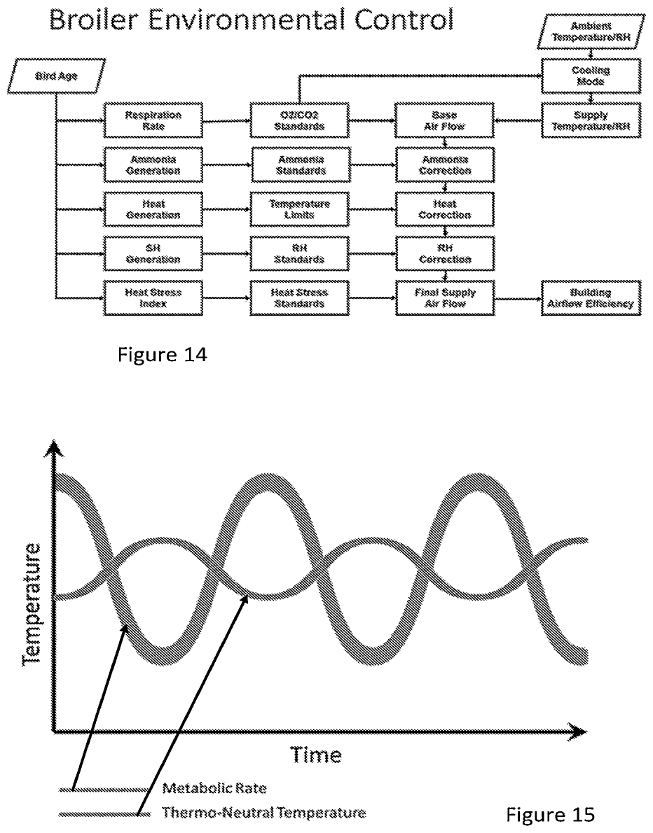

FIG. 14 illustrates a model of the environmental control protocol implemented by the controller of the present invention in a broiler housing;

FIG. 15 is a schematic graph illustrating variations in livestock metabolic rate and target temperature in accordance with a preferred embodiment of the invention;

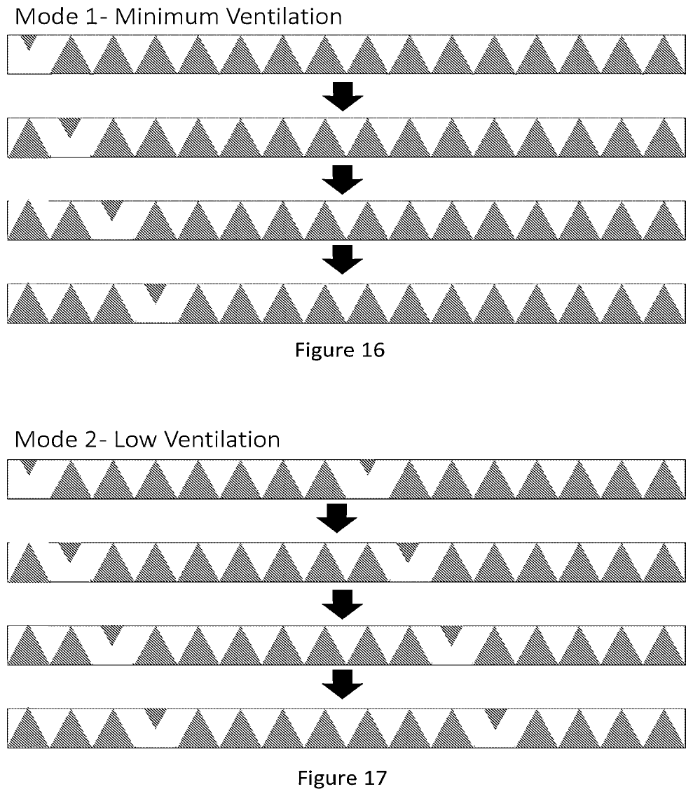

FIG. 16 is a schematic side-on view of an 16-bay livestock housing, with each bay having its own bay ventilation system controllable by a system controller, in which the livestock housing ventilation system is being controlled in a minimum ventilation mode;

FIG. 17 is a schematic side-on view of the 16-bay livestock housing of FIG. 16, in which the livestock housing ventilation system is being controlled in a low ventilation mode;

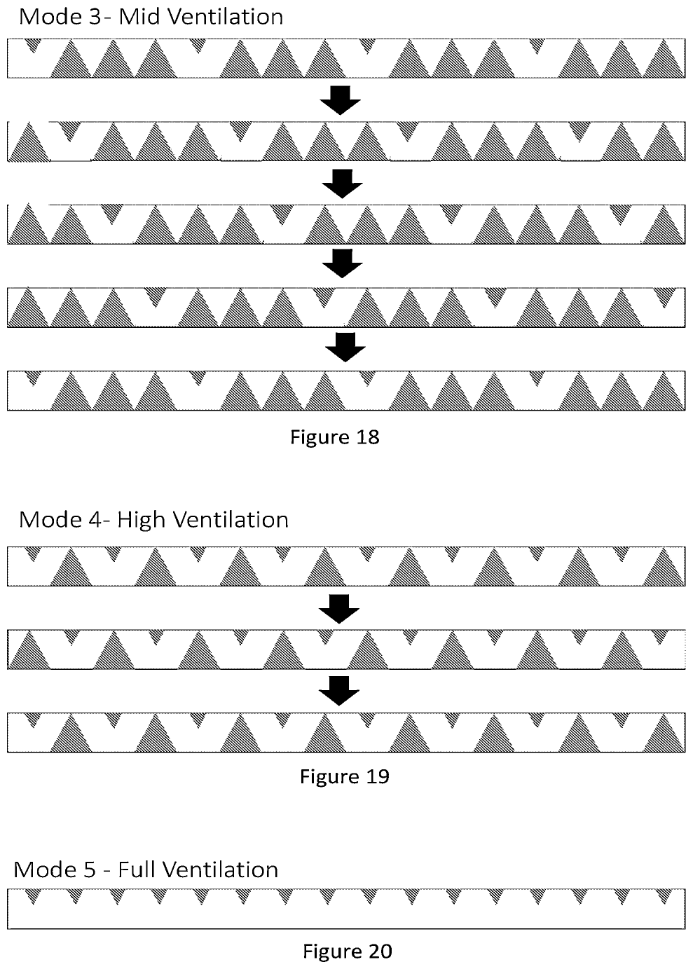

FIG. 18 is a schematic side-on view of the 16-bay livestock housing of FIG. 16, in which the livestock housing ventilation system is being controlled in a mid-ventilation mode;

FIG. 19 is a schematic side-on view of the 16-bay livestock housing of FIG. 16, in which the livestock housing ventilation system is being controlled in a high ventilation mode;

FIG. 20 is a schematic side-on view of the 16-bay livestock housing of FIG. 16, in which the livestock housing ventilation system is being controlled in a full ventilation mode.

FIG. 1, and the prior art broiler house ventilation system of FIGS. 2 to 4 are described in the background section above.

In the conventional broiler house 10 of FIGS. 2 to 4, windows 2 are provided in the housing side walls 4 to provide ventilation, and air inlets 6 above the windows are provided with adjustable aerofoil louvres 8, to direct the flow of outside air, termed “ambient” air, in through the air inlets. A series of air outlets 12 are provided at intervals along the peak of the gable roof 14, each outlet having its own unidirectional, fixed speed extract fan 16 which blows air vertically upwards out of the housing through the outlet. Lighting (not shown) and one or more heaters 18 are suspended from the gable roof.

Broilers 20 live on the floor 22 of the broiler house 10.

As described above, this prior art system has a number of shortcomings, including poor mixing of hot and cold air flows, which leads to non-uniformity of temperature and humidity in different areas of the housing. Poor energy efficiency and susceptibility to overheating on hot days are further problems with this prior art system.

FIGS. 5-8 illustrate a preferred embodiment of a ventilation system according to the present invention. The ventilation system can be implemented in a variety of different livestock housings or plant housings. For the purposes of illustration, the housing of FIGS. 5-8 will be described by reference to a broiler house 100.

In broiler house 100, windows 102 are provided in the housing side walls 104 to provide ventilation. Evaporative cooling pads 105 and variable inlet dampers 108 are arranged across air inlets 106, so that ambient air flowing into the building through the air inlets 106 flows through the evaporative cooling pads 105 and the variable inlet dampers 108. A water supply (not shown) is provided to supply water to the evaporative cooling pads, so that air flowing through the wetted pads is evaporatively cooled.

A series of air outlets 112 are provided at intervals along the peak of the roof 114. Each air outlet 112 is connected to an exhaust tunnel 115 with an outlet end 117 connected to the outlet 112 and an inlet end 119 positioned in the broiler house 100. A reversible-direction, variable-speed fan 116 is positioned in each exhaust tunnel 115 between the inlet end and the outlet end, and a closable backdraft damper 120 is positioned across each outlet 112. Two recirculation dampers 122 are arranged across recirculation openings 124 in the sidewall of the exhaust tunnel 115. The backdraft and recirculation dampers can be either automatically actuated by the controller, or mechanical such as gravity or spring return opened by a pressure change caused by the fan 116.

Lighting (not shown) and multiple heaters 118 are suspended from the roof of the housing 100.

A controller (not shown) is operatively connected to the fans 116, the water supply to the evaporative cooling pads 105, the inlet dampers 108, the heaters 118, the backdraft dampers 120 and the recirculation dampers 122.

The controller is also connected to an inside temperature sensor for sensing the temperature of the air inside the housing 100, an outside temperature sensor for sensing the temperature of ambient air outside the housing 100, and inside and outside relative humidity sensors. The controller receives signals from these sensors, and is programmed to operate the ventilation system in one of multiple operating modes in order to maintain the air inside the housing 100 within a target temperature range, such as within 1° C. of the optimum temperature for the particular age and weight of the birds, and a target relative humidity range, such as a humidity level which minimises heat stress in hot weather.

The controller may also be connected to a moisture meter or temperature sensor positioned on the floor of the housing, so that signals relating to the moisture level and/or temperature of litter on the housing floor is relayed to the controller.

The system is designed to operate in various modes, depending on the temperature and relative humidity inside the housing 100, and the ambient temperature and relative humidity outside the housing 100. For example, the ventilation mode is operable to provide:
Recirculation with heating
Recirculation
Ventilation
Ventilation with evaporative cooling

FIG. 6 illustrates the ventilation system operating in a ventilation mode. In ventilation mode, the fan 116 operates in exhaust mode, by driving air in a first airflow direction from the housing 100 out of the outlet 112. The recirculation dampers 122 close and the backdraft dampers 120 open. The inlet dampers 108 are opened, and no water is provided to the evaporative cooling pads 105, so ambient air flowing in through the inlets 106 is not evaporatively cooled.

The controller operates the system in ventilation mode when the ambient temperature and humidity are within the target temperature and humidity ranges desired inside the housing 100. In this mode, mixing fans (not shown) may also operate to drive airflows around the interior of the housing. The constant airflow around the inside of the housing encourages homogeneous temperature and humidity conditions for all broilers inside the housing 100.

If the temperature inside the housing 100 rises to above the target temperature range, the controller adjusts the operation of the ventilation system to reduce the temperature. If the ambient temperature is still within the target temperature range, then the controller may increase ventilation by increasing the speed of the fan 116, for example.

Alternatively, the controller may commence a cooling mode by starting the water supply to one or more of the evaporative cooling pads 105 to evaporatively-cool at least some of the incoming flows of air. If the ambient temperature exceeds the target temperature range, the controller may start the water supply to all of the evaporative cooling pads 105 to evaporatively cool all incoming air.

FIG. 7 illustrates the broiler house and ventilation system of FIG. 5, with the ventilation system operating in a cooling mode in which water is supplied to the evaporative cooling pads 105 to evaporatively-cool (adiabatically cool) the incoming flows of ambient air. In this mode, the recirculation dampers 122 are closed, the outlet dampers 120 are open, and the fan 116 operates in exhaust mode, by driving air in a first airflow direction from the housing 100 out of the outlet 112. In this mode, mixing fans (not shown) may also operate to drive airflows around the interior of the housing. The constant airflow around the inside of the housing encourages homogeneous temperature and humidity conditions for all broilers inside the housing 100.

The controller preferably operates the ventilation system in cooling mode if the ambient temperature is above the target temperature, so that ventilation alone cannot cool the interior of the housing to the desired target temperature.

FIG. 8 illustrates the ventilation system operating in a heating with recirculation mode. In this heating with recirculation mode the direction of the fan 116 is reversed compared to ventilation mode, so that the fan 116 is operating in a second airflow direction, and driving air downwards away from the outlet and into the interior of the housing 100. The backdraft dampers 120 close and the recirculation dampers 122 open, so that the fan 116 draws a stream of recirculated air through the recirculation openings 124 into the exhaust tunnel 115, and out of the inlet end 119 of the exhaust tunnel, downwards into the interior of the housing 100. Heaters 118 are turned on, and no water is supplied to the evaporative cooling pads 105.

By closing the backdraft dampers, opening the recirculation dampers and reversing the fan, the system recirculates air that has been heated by the heaters 118. That recirculated air is turbulently mixed with some fresh ambient air that is drawn in through the inlets 106. By blowing recirculated heated air downwards from the fan 116 onto the floor, a warm flow of air is provided to broilers on the floor of the housing 100, and a flow of air is provided which evaporates moisture and prevents ammonia build-up in the litter.

This heating and recirculation mode has the following advantages:
The positive downward flow of the fan distributes the air across the floor of the building.
The hot air from the heater is mixed before being discharged to the broilers
These effects result in homogenous conditions at the lower level where the broilers are populated.

This is illustrated as a closed loop system but it can be seen from the diagram that some ambient air is entering the building through the inlets. Air flow is required to maintain internal conditions including oxygen levels and relative humidity. This air flow is preferably created by one or more other ventilation systems in the building operating in ventilation mode.

The system may alternatively operate in a recirculation mode, similar to the heating and recirculation mode described in relation to FIG. 8, with the exception that the heaters 118 are turned off.

In recirculation mode, the controller closes (or partially closes) the backdraft dampers, opens (or partially opens) the recirculation dampers and reverses the fan, so that the system recirculates air that has been warmed by the livestock in the housing. That recirculated air is turbulently mixed with some fresh ambient air that is drawn in through the inlets 106. Mixing the ambient air and the recirculated air creates air conditions in the housing which have a temperature between the temperature of the ambient air and the temperature of the recirculated air, and a relative humidity between the relative humidity of the ambient air and the relative humidity of the recirculated air. The mixed flow of air is provided to broilers on the floor of the housing 100, which evaporates moisture and prevents ammonia build-up in the litter. The controller controls the proportions of the ambient air and the recirculated air flows by controlling the position of the dampers and the fan speed. By controlling the proportions in which these air flows are mixed, the temperature and relative humidity of the air inside the livestock housing 100 can be controlled to a target temperature and a target humidity, and maintained within allowable temperature and relative humidity levels.

In humidity control mode, at least some bays operate in this recirculation mode, in which some fresh ambient air is drawn in through the inlets 106 and some warmed air is recirculated.

FIGS. 9a and 9b illustrate alternative exhaust tunnels 115a and 115b which may be employed in the present invention.

As described above, each air outlet 112 is connected to an exhaust tunnel 115a, 115b with an outlet end 117 connected to the outlet 112 and an inlet end 119 positioned in the broiler house 100. A reversible-direction, variable-speed fan 116 is positioned in each exhaust tunnel 115a, 115b between the inlet end and the outlet end, and a closable backdraft damper 120a, 120b is positioned across each outlet 112. Two recirculation dampers 122a, 122b are arranged across recirculation openings 124 in the sidewall of the exhaust tunnel 115a, 115b.

The backdraft and recirculation dampers can be either automatically actuated by the controller, or mechanical such as gravity or spring return opened by a pressure change caused by the fan 116.

In FIG. 9a, the backdraft damper 120a and recirculation dampers 122a are passive non-return shutters/dampers. For example, these dampers may be passively actuated by gravity, or by springs.

In FIG. 9b, the backdraft damper 120b and recirculation dampers 122b are mechanically actuated variable-position flow control dampers, the position of which can be controlled by the controller.

FIG. 9c is a schematic illustration of an exhaust tunnel usable in the present invention. In FIG. 9c, the outlet dampers (backdraft dampers) 120a and recirculation dampers 122a are passive non-return shutters/dampers. These dampers are passively actuated by gravity, or by springs, so that they open and close in response to pressure changes in the tunnel caused by the direction and speed of the fan. This advantageously simplifies the control of the ventilation system and reduces installation and maintenance requirements, as the controller need not control actuation of the dampers as well as the operation of the fan.

FIG. 9d is a schematic illustration of the exhaust tunnel of FIG. 9c operating in an extract mode. In this mode, the fan 116 drives air in a first airflow direction from the housing 100 out of the outlet 112. The force of this airflow in the first airflow direction opens the outlet dampers 120a, but the recirculation dampers 122a remain closed.

FIG. 9e is a schematic illustration of the exhaust tunnel of FIG. 9c operating in a recirculation mode. In this mode, the controller operates the fan 116 in reverse, so that it drives air in a second airflow direction away from the outlet 112 and towards the floor of the housing 100. The force of this airflow in the second airflow direction creates a pressure drop in the tunnel which opens the recirculation dampers 122a and draws a flow of recirculated air from near the roof of the housing through the recirculation dampers into the tunnel. In this second airflow direction, the outlet dampers 120a remain closed. Although FIGS. 5-8 illustrate the invention as part of a broiler house 100 having a gabled roof, the invention may be implemented in housings having a variety of structures.

FIG. 10 illustrates exemplary schematic side-on cross-sections of eight differently configured housings each according to the present invention. In these schematics, air inlets (optionally with evaporative coolers) are indicated by arrows 900 pointing into the interior of the housings. As shown, each housing has at least one air inlet 900, but some structures comprise multiple air inlets 900. The air inlets 900 may also be located in a variety of positions in either the walls or roof of the housing. Air outlets and reversible fans are indicated in the schematics by back to back arrows 950. As shown, the air outlets and reversible fans are preferably located in a roof of the housing, but may alternatively be located in a housing wall, preferably high up the wall. Depending on the size or roof profile of the housing, one, two, or more air outlets and reversible fans 950 may be provided, and, one, two, or more air inlets 900 may be provided.

A particularly preferred embodiment of the present invention is illustrated by FIGS. 11 and 12. While again, the invention could be implemented to any livestock housing or plant housing divided into a number of sub-areas, or “bays”, the operation and benefits of the invention will be described by reference to a broiler house 200.

A broiler house is normally constructed in bays. A typical building could 20 m wide with over ten 6 m bays. There are no walls between bays, so air is free to flow along the broiler house from bay to bay. Typically, such a broiler house has used the ventilation system illustrated in FIGS. 2-4, in which each bay of the broiler house is ventilated in exactly the same way at all times, in the expectation that this will provide uniform conditions to broilers within the housing.

FIG. 11 illustrates a broiler house 200 made up of eight bays 100, each bay measuring 20 m wide by 6 m long. In the embodiment of FIGS. 11 and 12, each bay 100 comprises its own ventilation system as described above in relation to FIGS. 5 to 8. Thus each bay has its own air inlets 106 with evaporative cooling pads 105, and its own outlet 112, exhaust tunnel 115, and fan 116.

In this embodiment, a system controller (not shown) is connected to control the ventilation systems of each bay 100. The system controller is able to control each ventilation system individually, so that they may be operated all in the same mode—for example all in cooling mode or all in ventilation mode—or they may be operated differently to create a “hybrid” ventilation mode.

FIG. 12 illustrates the broiler house 200 with the ventilation system operating in a hybrid ventilation and recirculation mode. In this hybrid mode, the system controller operates every second bay 100 to operate in ventilation mode, while the other four bays operate in recirculation mode. This means that four of the eight bays 100 are drawing in ambient air, while the other four bays are in recirculation mode with the heaters turned off. In this mode, the fans 116 of adjacent bays are operating in opposite directions, which creates turbulent airflows inside the housing 200 that mixes the recirculated air with the colder incoming ambient air. This mixing creates mixed airflows that provide homogeneous temperature and humidity conditions throughout the interior of the broiler house 200, as the overlapping of air flows achieves a far greater degree of homogeneity compared with the current systems.

A variety of other hybrid modes are also possible. For example, the system controller may operate a hybrid heating mode by turning on the heaters in the mode above. Alternatively, the system controller may operate a hybrid cooling mode, by operating all bays 100 in ventilation mode, and supplying water to the evaporative cooling pads 105 of some bays only. These hybrid modes are particularly useful for precise control of the overall temperature and/or humidity conditions within the broiler house 200, as the system controller can adjust the mode of operation of each individual bay to arrive at the desired net result, as well as controlling the fan speeds, dampers and water supplies of each bay individually.

The system controller can control the following elements:
Setting the number of bays in different modes;
Implementing a rotation system for how each bay operates;
Setting the fan speeds according to internal and external factors.

The fan speed for the ventilation mode may be different to the fan speed for the recirculation systems.

The fan speeds may also differ for different bays according to variation in temperature or humidity conditions within the building.

When the ambient temperature is too high for the target inside temperature to be met then the system will go into full ventilation mode. If the system still cannot maintain compliant temperatures then the option of evaporative cooling can be enabled and the system can operate some or all bays in cooling mode.

For most applications, including broiler housing, the primary target of the ventilation system is to control the internal temperature of the building. This is key to the broiler heat stress and yield.

Factors taken into account by the system controller in this regard are illustrated in FIGS. 13 and 14. In this example broilers are used, but similar considerations apply to any livestock.

In heating mode the rate of incoming airflow is set by the respiration requirements of the broilers. The heating system makes up the heat loss from this incoming cool air and building losses, to maintain the target temperature inside the housing.

Where the ambient temperature is below the target internal temperature then the ‘hybrid’ mode of ventilation and recirculation is used. The recirculation creates homogenous conditions maintaining optimum yield conditions for the broilers. As the ambient temperature approaches the target temperature there is a thermal balance point where recirculation cannot function and the system changes to full ventilation mode. As the ambient temperature reaches or exceeds the target conditions then it is impossible to maintain the target temperature using ventilation and at this point the optional evaporative cooling is enabled.

The heat generated in the building is predominantly that from the broilers. This heat load is dependent upon many factors including breed, weight and age of broiler.

The heat rejection from the building is defined by the expression Q=MCpΔt where Q is heat (KW), M is mass flow rate (kg/s), Cp is specific heat capacity of air (J/kgK) and Δt is the temperature change of the air from inlet to exhaust.

For a ventilation system with flow rate V m³/s the mass flow rate Q=V*1.22 (based on an average exhaust temperature).

The specific heat capacity of air is ˜1.006.

For recirculation/vent mode to operate the minimum

$$Δ t >= Q / ( MCp ) \\ or \\ ( TE - TA ) >= Q / ( MCp )$$

In ventilation mode, the fan speed is set by the exhaust temperature which should be the target internal temperature where achievable. Therefore the exhaust fan speed should be set according to the mass flow rate required.

$$M = Q / ( Cp Δ t ) \\ Or \\ M = Q / ( Cp ( TE - TA ) )$$

The control system shall determine the operating modes based on the internal environmental standards, and in particular based on the age and weight of the broilers in the housing. For example with a 25° C. ambient temperature, different control modes will be required depending how old the broilers are. For incubation and hatching of very young broilers, internal temperatures of >30° C. are required, so if the ambient temperature is 25° C. the system controller would operate heating with recirculation mode. For older birds that require an optimum grown temperature of <30° C., the system controller would instead operate in ventilation mode, optionally with evaporative cooling if required.

Particularly advantageously, the system controller of the present invention may be programmed to account for the age and weight of the birds, and to automatically adjust the target temperature as the birds grow older and their optimum environmental conditions change. This can lead to improved livestock welfare, and also improved food conversion yields.

The system shall have the benefit of reduced energy use. By using variable speed fans rather than pulsed speed control the power consumed is reduced. The energy use of a fan is proportional to the cube of its speed, so using a fan continuously at 50% speed rather than pulsing on/off for 50% of the time uses 75% less energy.

By using the recirculation system during heating only the absolute minimum external air is drawn into the building and so the heating load is reduced while maintaining the target temperature.

The above shall reduce the overall carbon impact of broiler production, as well as having the benefit of increased yield of meat production by keeping the broilers at or very near to optimum performance temperature throughout their growth.

Homogenous conditions shall place more broilers in the optimum performance temperature zone, and the system shall permit closer control for standards to be adhered to for the optimum temperature zone requirements. Homogenous conditions shall also eliminate hot spots and cold spots inside the housing.

Additional benefits are that the use of variable-speed fans will mean that the system shall be quieter creating less stress for the broilers, and the air velocity over the birds will be minimised.

The evaporative cooling option shall reduce heat stress during hot weather and improve livestock welfare.

The continuous flow of air over all of the litter shall ensure even evaporation of broiler excreta and so maintain compliant RH levels. This shall also contribute to lower ammonia levels.

The system shall have the benefit of improve external environmental conditions for local residents, as the improved ventilation modes may lead to reduction or total removal of ammonia smells.

FIG. 15 is a schematic graph illustrating cyclical variations in livestock metabolic rate over time, and the cyclical variations in target temperature required to maintain the livestock in thermo-neutral air conditions in the housing. In a preferred embodiment of the invention, the controller is configured to vary the target temperature according to the metabolic rate of the livestock, so that the livestock are maintained in thermo-neutral temperatures.

FIGS. 16-20 illustrate a plurality of bay ventilation systems being controlled sequentially, according to a preferred embodiment of the present invention. FIGS. 16-20 are schematic side-on views of a 16-bay livestock housing, with each bay having its own bay ventilation system controllable by a system controller.

In FIG. 16, the system controller is controlling the plurality of bay ventilation systems to ventilate the livestock housing in a minimum ventilation mode. In this mode, only one bay ventilation system is operated in ventilation mode, while the other 15 bays are operated in recirculation mode, in which they mix air without drawing in any fresh air from outside. In order to ensure homogeneity of the air throughout the livestock housing, the bay ventilation systems are operated sequentially, with a first bay ventilation system being operated in ventilation mode for a set period (for example 2 minutes, or 5 minutes) before the first bay ventilation system is switched to recirculation mode and the adjacent bay is operated in ventilation mode for a set period. FIG. 16 illustrates the first four steps of the sequence, in which each of the 16 bays are preferably operated in ventilation mode for a set period before the sequence is restarted. Adjacent bays are thus each sequentially operated in ventilation mode for a set period, so that fresh air is regularly delivered throughout the large housing, and livestock positioned throughout the housing experience the same conditions.

FIG. 17 illustrates the same livestock housing as FIG. 16, which the livestock housing ventilation system is being controlled in a low ventilation mode in which two bay ventilation systems are operated in ventilation mode at any one time. The other 14 bays are operated in recirculation mode, in which they mix air without drawing in any fresh air from outside. Like FIG. 16, the two bays which are operating in ventilation mode are changed after a set period, to regularly vary the area of the housing receiving the incoming fresh air. In this mode, the control sequence restarts every eight steps.

FIG. 18 illustrates the same livestock housing as FIG. 16, which the livestock housing ventilation system is being controlled in a mid-ventilation mode in which four bay ventilation systems are operated in ventilation mode at any one time. The other 12 bays are operated in recirculation mode, in which they mix air without drawing in any fresh air from outside. Like FIGS. 16 and 17, the four bays which are operating in ventilation mode are changed after a set period, to regularly vary the areas of the housing receiving the incoming fresh air. In this mode, the control sequence restarts every four steps.

FIG. 19 illustrates the 16-bay livestock housing of FIG. 16, in which the livestock housing ventilation system is being controlled in a high ventilation mode in which eight of the sixteen bays are operated in ventilation mode at any one time. The other 8 bays are operated in recirculation mode, in which they mix air without drawing in any fresh air from outside. After a set period, the other eight bays are operated in ventilation mode for a set period, and so on.

FIG. 20 shows the livestock housing of FIG. 16, in which the livestock housing ventilation system is being controlled in a full ventilation mode, with all 16 bays operating in ventilation mode. This mode may be suitable, for example, in very hot weather.

1. A livestock-housing ventilation system for delivering air to the interior of a livestock housing, the system comprising:
a first air inlet arranged to provide a stream of ambient air to the interior of the housing;
an outlet for air to be exhausted out of the housing;
a reversible fan configurable to operate in a first airflow direction, in which the fan directs a flow of air from the housing towards the outlet, or a second airflow direction, in which the fan directs air away from the outlet and into the housing;
a recirculation damper arranged between the reversible fan and the outlet; and
a controller for controlling the fan,
additionally comprising a closable outlet damper arranged across the outlet, in which the outlet damper and the recirculation damper are configurable between an exhaust position, in which the outlet damper is open and the recirculation damper does not impede airflow out of the outlet, and a recirculation position, in which the outlet damper closes, or partially closes, the outlet, and the recirculation damper opens so to direct a stream of air back into the interior of the housing,
in which the recirculation damper and the outlet damper are passive non-return dampers, which are passively actuated to open and close in response to pressure changes caused by the direction and speed of the fan.

2. A ventilation system according to claim 1, in which the system comprises an exhaust tunnel, the exhaust tunnel having an inlet end arranged to receive air from the interior of the housing, and an outlet end arranged at the outlet from the housing, in which the reversible fan is positioned in the exhaust tunnel and configured to direct air in the first airflow direction towards the outlet end, or to direct air in the second airflow direction towards the inlet end, in which the recirculation damper is positioned across a recirculation opening in a wall of the exhaust tunnel, and in which the recirculation damper is configurable between an exhaust position, in which the recirculation damper closes the recirculation opening and does not impede airflow out of the outlet end, and an open position, in which the recirculation damper opens to direct air through the recirculation opening.

3. (canceled)

4. A ventilation system according to claim 1, in which the reversible fan is a variable speed fan, and in which the controller is configured to control both the direction and speed of the fan.

5. A ventilation system according to claim 1, comprising:
an outside temperature sensor for sensing a temperature of ambient air outside the livestock housing; and
an inside temperature sensor for sensing a temperature of air in the interior of the livestock housing;
in which the controller is configured to receive signals from the outside and inside temperature sensors, and to control the ventilation system to maintain the temperature of air in the interior of the livestock housing within a predetermined target temperature range.

6. A ventilation system according to claim 5, in which the controller is programmed to monitor the age or weight of livestock and to automatically adjust the predetermined target temperature range depending on the age of the livestock housed in the livestock housing, in which the controller is programmed to adjust the predetermined target temperature range continuously, every day, or every week.

7. (canceled)

8. A ventilation system according to claim 1, in which the controller is programmed to automatically adjust the target temperature over a set period, such as a 24 hour period, or in which the controller is programmed to continuously adjust the target temperature according to the metabolic rate of the livestock in the housing.

9. (canceled)

10. A ventilation system according to claim 1, additionally comprising an evaporative cooler configured to evaporatively cool the stream of ambient air flowing through the first inlet, in which the controller is configured to control the evaporative cooler, for example by controlling a water supply to the evaporative cooler, in which the controller is programmed to operate the ventilation system in a cooling mode, in which:
water is supplied to the evaporative cooler so that the evaporative cooler cools the stream of ambient air flowing through the first inlet into the interior of the livestock housing; and
the fan operates in a first airflow direction, so that the fan directs a flow of air out of the housing through the outlet.

11. (canceled)

12. (canceled)

13. A ventilation system according to claim 1, in which the controller is programmed to operate the ventilation system in a ventilation mode, in which:
a stream of ambient air is provided to the interior of the housing through the first inlet; and
the fan operates in a first airflow direction, so that the fan directs a flow of air out of the housing through the outlet.

14. (canceled)

15. A ventilation system according to claim 1, additionally comprising a heater for heating air inside the livestock housing, in which the controller is configured to control the heater, in which the controller is programmed to operate the ventilation system in a heating and recirculation mode, in which:
the heater is turned on to heat air inside the livestock housing;
the recirculation damper is opened; and
the fan is controlled to operate in the second airflow direction, so that the fan directs heated air through the recirculation damper and back into the housing.

16. (canceled)

17. (canceled)

18. A ventilation system according to claim 1, comprising:
an outside relative humidity sensor for sensing a relative humidity of ambient air outside the livestock housing; and
an inside relative humidity sensor for sensing a relative humidity of air in the interior of the livestock housing;
in which the controller is configured to receive signals from the outside and inside relative humidity sensors, and to control the ventilation system to maintain the relative humidity of air in the interior of the livestock housing within a predetermined target relative humidity range.

19. A ventilation system according to claim 1, in which the controller is programmed to operate in a humidity control mode, in which:
the ventilation system delivers a flow of ambient air and a flow of recirculated air to the housing in controlled proportions or a controlled flow ratio so as to maintain the interior of the livestock housing below a maximum relative humidity.

20. (canceled)

21. A ventilation system according to claim 19, in which, in the humidity control mode the controller is programmed to increase the target temperature to a temperature at which the air in the interior of the livestock housing is below the maximum relative humidity.

22. A ventilation system according to claim 1, in which the ventilation system comprises one or more litter moisture meters configured to measure the moisture levels of the bedding, or litter, on the floor of the housing, and in which the ventilation system comprises one or more litter temperature sensors configured to measure the temperature of the bedding, or litter, on the floor of the housing.

23. (canceled)

24. A ventilation system according preceding claim 1, in which the controller is configured to receive signals from a water meter, which indicate the quantity of water being provided to the housing as drinking water for the livestock, in which the controller is programmed to receive signals from the outside and inside relative humidity sensors and the water meter, and to control the ventilation system to maintain the relative humidity of air in the interior of the livestock housing within a predetermined target relative humidity range, and the litter moisture level below a maximum acceptable moisture level.

25. (canceled)

26. A ventilation system according to claim 1, in which the controller is programmed to operate in a litter moisture control mode when the moisture level in the litter on the floor of the housing exceeds a predetermined maximum acceptable moisture level, in which:
the ventilation system delivers a flow of ambient air and a flow of recirculated air to the housing in controlled proportions or a controlled flow ratio so as to maintain the interior of the livestock housing below a maximum relative humidity,
in which in litter moisture control mode the controller is programmed to control the ventilation system to: increase the target temperature of the air inside the housing to increase evaporation from the litter; decrease the relative humidity of the air inside the housing to increase evaporation from the litter; or increase the rate of airflow through the housing and over the litter to increase evaporation from the litter.

27. (canceled)

28. (canceled)

29. A ventilation system according to claim 1, in which the controller is programmed to monitor the temperature inside the housing, the relative humidity inside the housing, and the activity of the livestock in the housing, and to calculate a livestock stress index based on the monitored parameters, in which the controller is configured to increase or decrease the target temperature, or increase or decrease the target relative humidity, in order to provide conditions inside the housing that will lower the livestock stress index.

30. (canceled)

31. A ventilation system according to claim 1, in which the livestock housing is sub-divided into a plurality of bays, and in which the ventilation system comprises a plurality of bay ventilation system for providing a stream of controlled-temperature air to each bay, in which each bay ventilation system is a ventilation system according to any preceding claim, and in which a system controller is configured to control the plurality of bay ventilation systems, in which the system controller is programmed to control the plurality of bay ventilation systems selectively either to operate in the same way as each other, or to operate in a hybrid mode in which some bay ventilation systems operate differently to others, so that different bay ventilation systems deliver air of different temperatures, humidities or flow rates.

32. (canceled)

33. (canceled)

34. (canceled)

35. (canceled)

36. (canceled)

37. A ventilation system according to claim 31, in which the system controller is programmed to sequentially vary the operating modes of the bay ventilation systems within the housing.

38. A ventilation system according to claim 31, in which the system controller is programmed to operate a first bay ventilation system in a first mode and a second bay ventilation system in a second mode for a first set period, and then to switch the first bay ventilation system into the second mode and operate the second bay ventilation system in the first mode for a second set period.

39. (canceled)

40. (canceled)

41. Livestock-housing, comprising a livestock-housing ventilation system according to claim 1.
